(19) United States
(12) Patent Application Publication
(10) Pub. No.: US 2026/0044216 A1
(43) Pub. Date: Feb. 12, 2026

(54) Intelligent Method to Manage and Orchestrate User Digital Assets Leveraging Spatial Computing Device

(71) Applicant: Bank of America Corporation, Charlotte, NC (US)

(72) Inventor: Shailendra Singh, Maharashtra (IN)

(21) Appl. No.: 18/795,340

(22) Filed: Aug. 6, 2024

(51) Int. Cl. G06F 3/01; G06F 21/57; G06T 19/00; G06V 40/16; H04W 84/12

(52) U.S. Cl. CPC G06F 3/017; G06F 21/577; G06T 19/006; G06V 40/172; H04W 84/12

(57) ABSTRACT

An intelligent method for managing and orchestrating digital assets leveraging spatial computing devices is disclosed. The method enables real-time identification and extraction of user digital asset details, including software and hardware assets, using a LiDAR-based face detection system integrated with spatial computing devices. The invention includes a spatial scanning engine, user asset extraction engine, and spatial anchor programming engine, allowing asset management associates to annotate, alter, and manipulate user assets via an interactive spatial interface. Gesture recognition capabilities enable intuitive control of digital assets, while deep learning modules enhance accuracy in user and asset identification. The method supports the formation of local area networks for collaborative asset management and real-time provisioning of digital assets based on spatial and geolocation data. An asset anomaly event engine detects and reports compliance issues, ensuring security and efficient management of digital assets. The homomorphic encryption layer secures data during processing, maintaining privacy.

### TECHNICAL FIELD

The inventions disclosed herein pertain to the field of computer graphics processing and operator interface processing systems. This includes technologies and methods for the graphical representation of data and the interactive manipulation of digital assets through user interfaces. The invention leverages spatial computing devices and augmented reality interfaces to enable asset management associates to visually monitor, orchestrate, and manage digital assets in real-time. This involves the use of gesture recognition and augmented reality to provide an interactive and intuitive user experience for digital asset management.

### DESCRIPTION OF THE RELATED ART

The management of digital assets within organizations presents numerous challenges, particularly in ensuring compliance with security protocols and efficient orchestration of these assets. Employees are provisioned with various digital and physical assets necessary for their roles, including software licenses, hardware devices, and access to sensitive data. The responsibility of overseeing these assets falls on asset management associates, who must ensure that these assets are properly utilized, maintained, and secured. Traditional methods of asset management are often static, relying on periodic audits and manual updates, which can lead to delays in addressing security vulnerabilities and inefficiencies in asset allocation.

A significant issue with current asset management systems is their inability to provide real-time monitoring and management. This lack of immediacy means that potential security breaches or non-compliance issues may go undetected for extended periods, increasing the risk to the organization. Asset management associates often struggle to keep track of the myriad of assets assigned to users, especially in large organizations where employees frequently change roles or departments. This dynamic environment necessitates a more responsive and adaptable approach to asset management, one that can quickly adapt to changes and provide up-to-date information.

Moreover, existing systems typically do not integrate well with each other, leading to silos of information that are difficult to manage collectively. This fragmentation hinders the ability of asset management associates to get a comprehensive view of all digital assets and their status. The manual processes involved in reconciling this information are time-consuming and prone to errors, further complicating the task of ensuring compliance and security. Additionally, the lack of integration can result in redundant asset allocations, where multiple licenses or devices are issued unnecessarily, leading to increased costs and inefficiencies.

The challenge is further compounded by the increasing sophistication of cyber threats. As organizations become more reliant on digital assets, the potential attack surface for malicious actors expands. Asset management associates must be vigilant in identifying and mitigating these threats, which requires not only real-time monitoring but also predictive capabilities to anticipate potential vulnerabilities. Current systems lack the advanced analytics and machine learning capabilities necessary to provide these insights, leaving organizations exposed to potential security breaches.

Another significant problem is the difficulty in ensuring that all digital assets comply with the organization's security policies. This includes ensuring that all software is up-to-date with the latest patches, licenses are valid, and access is restricted to authorized personnel only. Manual checks are insufficient in maintaining compliance, especially when dealing with a large number of assets. Non-compliance can result in severe consequences, including data breaches, financial charges, and damage to the organization's reputation.

The lack of a user-friendly interface for asset management is also a notable issue. Many existing systems are cumbersome and require specialized knowledge to operate effectively. This can lead to bottlenecks, as only a few trained individuals can manage the system, delaying the response to emerging issues. Additionally, these systems often do not provide intuitive ways to visualize asset data, making it challenging for asset management associates to quickly assess the status and compliance of digital assets.

In many organizations, asset management associates are unable to effectively collaborate due to the limitations of current systems. The need for collaborative tools is critical, especially in complex environments where multiple associates must work together to manage assets. Existing systems often do not support real-time collaboration, making it difficult to coordinate efforts and share information efficiently. This lack of collaboration can result in inconsistent asset management practices and overlooked vulnerabilities.

Furthermore, current asset management practices do not adequately address the need for contextual awareness. Understanding the physical and digital context in which assets are used is crucial for making informed management decisions. For example, knowing the location of a device and its user can help in identifying unauthorized access or potential security risks. However, traditional systems do not provide the necessary spatial and contextual information, limiting the effectiveness of asset management strategies.

The process of provisioning and de-provisioning assets is another area that presents significant challenges. In many organizations, this process is manual and slow, resulting in delays that can impact productivity. For instance, when an employee changes roles or leaves the organization, the reassignment or revocation of digital assets must be done promptly to prevent unauthorized access. The inefficiencies in current provisioning processes can leave gaps that malicious actors can attack.

Lastly, the increasing reliance on remote work and mobile devices has introduced new complexities in asset management. Ensuring that remote employees adhere to security policies and that their devices are properly managed is a daunting task with traditional systems. The lack of real-time visibility and control over these assets can lead to security lapses and non-compliance with organizational policies.

The long-felt and unmet need for the invention is evident in the persistent challenges faced by organizations in managing and securing digital assets. Traditional asset management systems have failed to keep pace with the evolving digital landscape, leaving organizations vulnerable to security threats and inefficiencies. The need for a dynamic, real-time, and integrated approach to digital asset management has never been more critical. This invention addresses these challenges by providing a comprehensive solution that enhances the visibility, control, and security of digital assets, meeting the urgent demands of modern organizations.

### SUMMARY OF THE INVENTION

The inventions described herein involve advanced technology in the field of computer graphics processing and operator interface systems. It centers on the graphical representation and interactive manipulation of digital assets using spatial computing devices and augmented reality interfaces. These technologies enable asset management associates to visually monitor, orchestrate, and manage digital assets in real-time. The system utilizes gesture recognition and augmented reality to provide a more interactive and intuitive user experience for digital asset management, enhancing both efficiency and accuracy.

At the center of the invention is the integration of a LiDAR face detection system with spatial computing devices. This system can accurately identify users and extract detailed information about their digital assets, including both software and hardware assets, as well as access provisions. By using spatial computing devices, asset management associates can quickly access up-to-date information about all relevant assets, facilitating efficient and informed decision-making. The system ensures that asset management processes are dynamic and responsive, adapting quickly to changes in user roles and organizational needs.

The system allows asset management associates to manipulate digital assets using gesture-based controls. Through an interactive spatial computing interface, associates can add, delete, transfer, or modify user digital assets. This gesture-based control system makes asset management more efficient and user-friendly, reducing the need for extensive training and specialized knowledge. The system also allows associates to alter access provisioning for target users, ensuring that only authorized personnel have access to specific digital assets. This functionality enhances security and ensures that asset management practices are aligned with organizational policies.

One of the core features of this invention is the heatmap visualization, which can be viewed on the spatial computing device. This heatmap displays digital asset anomalies related to user information security issues. Compliance parameters visualized on the heatmap include inadequate patch levels on devices, outdated software versions, non-permissible software installations, antivirus status, software license expiration, and unauthorized server access, among others. By providing a clear and intuitive overview of these compliance parameters, the heatmap helps asset management associates quickly identify and address potential security risks, ensuring that all digital assets comply with the organization's security policies.

The invention also facilitates the formation of a local area network with other asset management associates through the pairing of spatial computing devices. This feature supports interactive and collaborative asset provisioning, enhancing teamwork and coordination among associates. By enabling multiple users to work together in managing digital assets, the system ensures that asset management practices are consistent and comprehensive, minimizing the risk of overlooked vulnerabilities. This collaborative capability is particularly beneficial in large organizations where efficient communication and coordination are essential for effective asset management.

Another core feature of the invention is its support for real-time asset provisioning. The system enables asset management associates to select multiple users simultaneously for real-time asset provisioning, allowing for efficient management and assignment of digital assets. This real-time capability ensures that asset management processes are dynamic and responsive, adapting quickly to changes in user roles and organizational needs. The system also allows asset managers to generate asset anchor tags and label them to users, simplifying the process of tagging and tracking digital assets.

The ability to recognize users' location spatial maps, which include their surroundings and geolocation, further enhances the accuracy and context-awareness of digital asset management. This recognition capability enables the provisioning of digital assets until the asset management associate can see the user in a defined spatial map and geolocation in real-time. This feature, known as vision-oriented asset provisioning, ensures precise and context-aware management of digital assets, enhancing the overall security and efficiency of the system.

The technology encompasses several key components that make the system robust and effective. These include a spatial scanning engine, which scans and identifies spatial information related to users and their environments; a user asset extraction engine, which extracts detailed information about user digital assets; a spatial anchor programming engine, which allows for the programming and management of spatial anchors used to tag and track assets; an asset orchestration engine, which manages the overall orchestration of digital assets; an asset anomaly event engine, which detects and reports compliance issues; an asset management rule engine, which enforces organizational rules and policies related to asset management; a gesture engine, which processes gesture-based inputs from asset management associates; and an asset deployment engine, which handles the deployment of digital assets to users.

Additionally, the system includes a deep learning module, which enhances the accuracy of user and asset identification through advanced analytics and machine learning capabilities. This module allows the system to learn and adapt over time, improving its performance and accuracy in managing digital assets. The deep learning module is particularly useful in identifying patterns and anomalies that may not be immediately apparent, providing asset management associates with valuable insights into the state and security of digital assets.

Gesture-based controls are a significant aspect of this invention, enabling asset management associates to interact with and manipulate digital assets through intuitive gestures. This approach makes the system user-friendly and efficient, reducing the need for specialized knowledge and extensive training. The interactive spatial computing interface allows for seamless addition, deletion, transfer, and modification of digital assets, as well as the alteration of access provisioning for target users. This intuitive interface enhances the overall user experience, making digital asset management more accessible and efficient.

The heatmap visualization feature is another innovative aspect of the system. This feature allows asset management associates to view a visual representation of digital asset anomalies related to user information security issues. By providing a clear and intuitive overview of compliance parameters, the heatmap helps associates quickly identify and address potential security risks, ensuring that all digital assets comply with the organization's security policies. This visual tool is particularly useful in large organizations, where managing and monitoring a vast number of digital assets can be challenging.

Collaboration among asset management associates is also a crucial feature of this invention. The system supports the formation of local area networks, enabling associates to pair their spatial computing devices for interactive, collaborative asset provisioning. This feature enhances teamwork and coordination, allowing multiple associates to work together in managing digital assets effectively and efficiently. The collaborative nature of the system ensures that asset management practices are consistent and comprehensive, minimizing the risk of overlooked vulnerabilities.

The ability to generate asset anchor tags and label them to users is another key feature of the system. This functionality simplifies the process of tagging and tracking digital assets, ensuring that each asset is properly assigned and managed. The system's recognition of users' location spatial maps, which include surroundings and geolocation, further enhances the accuracy and context-awareness of digital asset management. This capability ensures that digital assets are managed in a way that is both precise and responsive to the specific needs and contexts of users.

The deep learning module integrated into the system plays a crucial role in enhancing its capabilities. This module utilizes advanced machine learning techniques to continuously improve the accuracy and efficiency of digital asset management. By analyzing large datasets and identifying patterns, the deep learning module provides predictive insights that help asset management associates anticipate potential issues before they arise. This proactive approach to asset management significantly enhances the security and efficiency of the system.

In addition to the deep learning module, the system's asset anomaly event engine is designed to detect and report compliance issues in real-time. This engine continuously monitors digital assets for any anomalies or deviations from established security policies. When an issue is detected, the engine generates an alert, enabling asset management associates to take immediate corrective action. This real-time monitoring and alerting capability is essential for maintaining the integrity and security of digital assets.

The gesture engine is another key component of the system, processing gesture-based inputs from asset management associates. This engine allows associates to control the system and manage digital assets using intuitive gestures. By eliminating the need for traditional input devices such as keyboards and mice, the gesture engine streamlines the asset management process and enhances the overall user experience. This innovative approach to user interaction makes the system more accessible and efficient.

The spatial scanning engine and user asset extraction engine work together to provide a comprehensive view of digital assets and their associated users. The spatial scanning engine scans the environment to identify spatial information related to users and their surroundings. This information is then processed by the user asset extraction engine, which extracts detailed data about the digital assets assigned to each user. This integrated approach ensures that asset management associates have access to accurate and up-to-date information, enabling them to make informed decisions about asset provisioning and management.

The spatial anchor programming engine is responsible for the programming and management of spatial anchors used to tag and track digital assets. This engine allows asset management associates to create and manage spatial anchors, ensuring that digital assets are properly tagged and tracked throughout their lifecycle. The spatial anchor programming engine is an essential component of the system, providing the foundation for accurate and efficient asset management.

The asset orchestration engine manages the overall orchestration of digital assets, coordinating the various components of the system to ensure seamless operation. This engine is responsible for implementing asset management policies and procedures, ensuring that digital assets are utilized and maintained in accordance with organizational guidelines. The asset orchestration engine plays a critical role in maintaining the integrity and security of digital assets, ensuring that they are managed effectively and efficiently.

The asset deployment engine handles the deployment of digital assets to users, ensuring that assets are provisioned in a timely and accurate manner. This engine coordinates with other components of the system to ensure that digital assets are deployed based on real-time data and contextual information. The asset deployment engine is an essential part of the system, providing the functionality needed to manage digital assets dynamically and responsively.

In conclusion, the inventions provide a comprehensive, real-time, and integrated approach to digital asset management. By leveraging advanced technologies such as LiDAR, gesture recognition, and augmented reality, the system offers an intuitive, interactive, and efficient solution for managing digital assets. The innovative features and robust components of this system ensure efficient, secure, and effective management of digital assets, meeting the demands of modern organizations. The invention represents a significant advancement in the field of digital asset management, providing organizations with the tools they need to manage their assets in a more efficient, secure, and responsive manner.

In light of the foregoing, the following provides a simplified summary of the present disclosure to offer a basic understanding of its various parts. This summary is not exhaustive, nor does it limit the exemplary aspects of the inventions described herein. It is not designed to identify key or critical elements or steps of the disclosure, nor to define its scope. Rather, it is intended, as understood by a person of ordinary skill in the art, to introduce some concepts of the disclosure in a simplified form as a precursor to the more detailed description that follows. The specification throughout this application contains sufficient written descriptions of the inventions, including exemplary, non-exhaustive, and non-limiting methods and processes for making and using the inventions. These descriptions are presented in full, clear, concise, and exact terms to enable skilled artisans to make and use the inventions without undue experimentation, and they delineate the best mode contemplated for carrying out the inventions.

In some arrangements, a method for managing and orchestrating digital assets leveraging spatial computing devices includes identifying a user by using a LiDAR face detection system integrated with a spatial computing device. This system extracts user digital asset details, including information on assigned digital and physical computing assets. The method involves manipulating user digital assets through an interactive spatial computing interface by an asset management associate using gesture-based controls. This manipulation includes adding, deleting, transferring, or modifying user digital assets and altering access provisioning for the user. Additionally, the method includes displaying a heatmap visualization of digital asset anomalies associated with user information security issues on the spatial computing device.

The anomalies include inadequate patch levels, outdated software versions, non-permissible software installations, antivirus status, software license expiration, and unauthorized server access. The method also forms a local area network by pairing spatial computing devices with other asset management associates for interactive collaborative asset provisioning, enabling real-time communication and coordination among associates. It allows the asset management associate to select multiple users simultaneously for real-time asset provisioning, facilitating efficient and concurrent management of digital assets. Furthermore, the method generates asset anchor tags using the spatial computing device and labels them to users for tracking and managing digital assets, ensuring accurate tagging and easy retrieval of asset information. The spatial computing device also recognizes users' location spatial maps, including surroundings and geolocation, enabling the provisioning of digital assets until the asset management associate can see the user in a defined spatial map and geolocation in real-time, thereby providing context-aware asset management. This method also involves scanning spatial information related to users and their environments with a spatial scanning engine to ensure precise and detailed spatial data collection and extracting detailed information about user digital assets with a user asset extraction engine to provide comprehensive and up-to-date asset information.

In some arrangements, the method includes programming spatial anchors for tagging and tracking digital assets with a spatial anchor programming engine, facilitating the management and organization of digital assets based on spatial anchors. This ensures accurate and efficient tracking of assets within the system.

In some arrangements, the method further includes orchestrating the overall management of digital assets according to organizational policies and procedures with an asset orchestration engine. This ensures compliance and efficient utilization of digital assets, allowing for effective and organized asset management practices.

In some arrangements, the method involves detecting compliance issues related to digital asset management with an asset anomaly event engine and generating alerts for asset management associates. This enables prompt corrective actions, ensuring the security and integrity of digital assets.

In some arrangements, the method includes enforcing organizational rules and policies related to digital asset management with an asset management rule engine, maintaining consistent and secure asset management practices. This ensures that all digital assets are managed according to predefined guidelines and standards.

In some arrangements, the method involves processing gesture-based inputs from asset management associates with a gesture engine for controlling and managing digital assets. This enhances user interaction and control over digital assets, making the system more intuitive and efficient to use.

In some arrangements, the method includes deploying digital assets to users based on real-time data and contextual information with an asset deployment engine. This ensures timely and accurate provisioning of assets, aligning with the dynamic needs of the organization.

In some arrangements, the method involves analyzing large datasets to identify patterns and provide predictive insights for digital asset management with a deep learning module. This improves decision-making and proactive management, allowing for better anticipation of potential issues and optimization of asset utilization.

In some arrangements, the method includes improving the accuracy and efficiency of digital asset management over time through continuous learning and adaptation with the deep learning module. This ensures that the system evolves and improves with changing needs and environments.

In some arrangements, the method involves visualizing compliance parameters and security risks through an intuitive user interface on the spatial computing device to assist asset management associates in making informed decisions. This enhances the overall efficiency and effectiveness of digital asset management by providing clear and actionable insights.

In some arrangements, a system for managing and orchestrating digital assets leveraging spatial computing devices includes a LiDAR face detection system integrated with a spatial computing device. This system is configured to identify a user and extract user digital asset details, including information on assigned digital and physical computing assets, providing precise and reliable user identification under various lighting and environmental conditions. The system features a gesture-based control interface on the spatial computing device, allowing an asset management associate to manipulate user digital assets. This manipulation includes adding, deleting, transferring, or modifying user digital assets and altering access provisioning for the user. The gesture-based control interface recognizes a wide range of gestures to ensure accurate and intuitive control.

In some arrangements, the system includes a heatmap visualization module on the spatial computing device. This module is configured to display digital asset anomalies associated with user information security issues. The anomalies include inadequate patch levels, outdated software versions, non-permissible software installations, antivirus status, software license expiration, and unauthorized server access. The heatmap visualization module provides real-time updates and interactive features for detailed anomaly analysis.

In some arrangements, the system features a networking module on the spatial computing device, configured to pair with other spatial computing devices to form a local area network for interactive collaborative asset provisioning. This enables real-time communication and coordination among asset management associates, with the networking module supporting secure and encrypted communication channels to protect sensitive data.

In some arrangements, the system includes a user selection module on the spatial computing device. This module is configured to allow the asset management associate to select multiple users simultaneously for real-time asset provisioning, allowing for efficient and concurrent management of digital assets. The user selection module provides advanced filtering and sorting options to streamline the selection process.

In some arrangements, the system features an asset tagging module on the spatial computing device, configured to generate asset anchor tags and label them to users for tracking and management of digital assets. This ensures accurate tagging and easy retrieval of asset information, utilizing unique identifiers and metadata for comprehensive asset tracking.

In some arrangements, the system includes a spatial recognition module on the spatial computing device. This module is configured to recognize users' location spatial maps, including surroundings and geolocation, and enable the provisioning of digital assets until the asset management associate sees the user in a defined spatial map and geolocation in real-time. This capability provides context-aware asset management, with the spatial recognition module integrating with geolocation services to enhance accuracy and context-awareness.

In some arrangements, the system features a spatial scanning engine configured to scan and identify spatial information related to users and their environments. This ensures precise and detailed spatial data collection, with the spatial scanning engine supporting high-resolution scanning and real-time data processing.

In some arrangements, the system includes a user asset extraction engine configured to extract detailed information about user digital assets. This provides comprehensive and up-to-date asset information, with the user asset extraction engine interfacing with various asset management databases and systems to ensure comprehensive data extraction.

In some arrangements, the system includes a spatial anchor programming engine configured to program spatial anchors for tagging and tracking digital assets. This facilitates the management and organization of digital assets based on spatial anchors, with the spatial anchor programming engine supporting dynamic anchor adjustments and multi-anchor configurations for enhanced tracking accuracy.

In some arrangements, the system features an asset orchestration engine configured to manage the overall orchestration of digital assets according to organizational policies and procedures. This ensures compliance and efficient asset utilization, with the asset orchestration engine incorporating machine learning algorithms to optimize asset allocation and utilization based on historical data and predictive analytics.

In some arrangements, the system includes an asset anomaly event engine configured to detect compliance issues related to digital asset management and generate alerts for asset management associates. This enables prompt corrective actions, with the asset anomaly event engine utilizing advanced anomaly detection techniques and customizable alert thresholds to ensure timely identification of potential issues.

In some arrangements, the system features an asset management rule engine configured to enforce organizational rules and policies related to digital asset management. This maintains consistent and secure asset management practices, allowing for the creation and modification of complex rule sets and integrating with other compliance management systems for comprehensive policy enforcement.

In some arrangements, the system includes a gesture engine configured to process gesture-based inputs from asset management associates for controlling and managing digital assets. This enhances user interaction and control over digital assets, with the gesture engine supporting customizable gesture sets and providing feedback mechanisms to ensure accurate gesture recognition and execution.

In some arrangements, the system features an asset deployment engine configured to deploy digital assets to users based on real-time data and contextual information. This ensures timely and accurate provisioning of assets, integrating with workflow management systems to automate and streamline the deployment process.

In some arrangements, the system includes a deep learning module configured to analyze large datasets to identify patterns and provide predictive insights for digital asset management. This improves decision-making and proactive management, with the deep learning module continuously updating its models based on new data to ensure high accuracy and relevance of predictions.

In some arrangements, the system features a visualization module on the spatial computing device configured to visualize compliance parameters and security risks through an intuitive user interface. This assists asset management associates in making informed decisions, enhancing the overall efficiency and effectiveness of digital asset management, with the visualization module providing interactive dashboards, customizable reports, and real-time data visualization tools.

In some arrangements, a method for managing digital assets leveraging spatial computing devices includes identifying a user by using a spatial computing device, which extracts user digital asset details, including information on assigned digital and physical computing assets. The spatial computing device allows an asset management associate to manipulate user digital assets through an interactive interface. This manipulation includes adding, deleting, transferring, or modifying user digital assets and altering access provisioning for the user.

In some arrangements, the method includes displaying digital asset anomalies associated with user information security issues on the spatial computing device. These anomalies may include inadequate patch levels, outdated software versions, non-permissible software installations, antivirus status, software license expiration, and unauthorized server access. The display provides real-time updates and detailed anomaly information.

In some arrangements, the method features the formation of a network by the spatial computing device, pairing with other spatial computing devices for collaborative asset provisioning. This enables real-time communication and coordination among asset management associates, ensuring efficient collaboration.

In some arrangements, the method includes selecting multiple users for asset provisioning using the spatial computing device. This selection allows for efficient and concurrent management of digital assets, streamlining the process for asset management associates.

In some arrangements, the method involves generating asset tags using the spatial computing device and labeling them to users for tracking and managing digital assets. This ensures accurate tagging and easy retrieval of asset information, enhancing the efficiency of asset management.

In some arrangements, the method includes recognizing users' locations using the spatial computing device. This involves recognizing users' spatial maps, including surroundings and geolocation, enabling the provisioning of digital assets until the asset management associate can see the user in a defined spatial map and geolocation in real-time. This provides context-aware asset management, ensuring that assets are managed accurately based on their location and usage context.

The following description and claims, in conjunction with the drawings-all integral parts of this specification-will clarify various features and characteristics of the current technology. Like reference numerals in the figures correspond to similar parts, enhancing understanding of the technology's methods of operation and the functions of related structural elements, as well as the synergies and economies of their combinations. Some of the processes or procedures described here may be implemented, in whole or in part, as computer-executable instructions recorded on computer-readable media, configured as computer modules, or in other computer constructs. These steps and functionalities may be executed on a single device or distributed across multiple devices interconnected with one another. However, it is important to acknowledge that the drawings primarily serve for descriptive and illustrative purposes and are not intended to delineate the limits of the invention. Unless contextually evident, the singular forms of “a,” “an,” and “the” used throughout the specification and claims should be interpreted to include their plural counterparts.

### BRIEF DESCRIPTION OF DRAWINGS

FIG. 1 depicts a concept diagram for collaborative asset management, showing asset management associate(s) using spatial computing device(s) for management and decisioning on a local area network wherein user digital assets are viewed via augmented reality interface and users have special attributes and digital asset details.

FIG. 2 illustrates a method for managing digital assets using a spatial computing device, featuring an augmented reality interface that allows asset management associates to generate tags and labels, and assign assets through intuitive swipe gestures. The diagram highlights the integration of real-time manipulation, collaborative networking, and advanced spatial data processing to streamline and enhance the asset management process.

FIG. 3 illustrates a system for multi-digital asset provisioning using spatial computing devices, enabling an asset management associate to select and provision digital assets to multiple users in real-time through an augmented asset interface. The interface shows sample anchor tags that can be assigned to user asset devices, including laptops, tablets, and smartphones, while supporting intuitive gesture-based controls and real-time updates.

FIG. 4 illustrates a digital asset provisioning system that leverages spatial maps and geolocation data to manage assets in real-time. The system ensures that digital assets are only provisioned to users when their location is visually confirmed by an asset management associate using a spatial computing device equipped with augmented reality and LiDAR technology.

FIG. 5 illustrates a sophisticated asset management system using a spatial computing device to create and program asset anchors in real-time based on established rules. The system enables users to manage their digital assets dynamically through an augmented reality interface, utilizing user assets anchor tags for precise tracking and compliance.

FIG. 6 illustrates an asset anomaly detection system that uses a heatmap to visually highlight anomalies in user assets, such as non-permissible technology or components lacking updates, managed through spatial computing devices.

FIG. 7 illustrates a user anomaly detection system that uses a spatial computing device to identify and manage users who are non-compliant with digital asset rules or policies in real-time. The system categorizes users based on compliance scores, enabling asset management associates to take immediate corrective actions through an augmented reality interface.

FIG. 8 depicts the architecture diagram for a spatial computing-based digital asset management system, detailing the various engines and modules involved in asset management and orchestration.

FIGS. 9A-9F collectively provide a sequence diagram for managing and orchestrating digital assets using a spatial computing device, involving steps such as identifying user assets, manipulating them via gesture controls, and ensuring compliance through anomaly detection and rule enforcement. This comprehensive approach leverages advanced technologies like LiDAR, real-time heatmaps, and predictive analytics to enhance the efficiency, security, and accuracy of digital asset management.

FIG. 10 depicts a sample flow chart outlining the steps for managing and orchestrating digital assets using a spatial computing device. The steps include identifying users via a LiDAR face detection system, extracting digital asset details, manipulating assets using gesture-based controls, displaying heatmap visualizations of anomalies, forming a local area network for collaborative asset provisioning, and enforcing asset management rules.

FIG. 11 shows a sample entity relationship diagram for the digital asset management system, detailing various engines and modules such as the Asset Anomaly Event Engine, Asset Management Rule Engine, Gesture Engine, Spatial Anchor Programming Engine, Asset Deployment Engine, Visualization Module, and Deep Learning Module. This diagram illustrates the relationships and interactions between these components in managing and orchestrating digital assets.

### DETAILED DESCRIPTION

The inventions described herein pertain to the advanced field of computer graphics processing and operator interface systems, specifically targeting the graphical representation and interactive manipulation of digital assets through the use of spatial computing devices and augmented reality interfaces. These technologies enable asset management associates to monitor, orchestrate, and manage digital assets in real-time, offering a dynamic and intuitive approach to digital asset management. At its core, the system integrates a LiDAR face detection system with spatial computing devices to accurately identify users and extract detailed information about their digital assets, which includes both software and hardware assets as well as access provisions.

The use of spatial computing devices allows asset management associates to access up-to-date information about all relevant assets quickly, facilitating efficient and informed decision-making. This is achieved through a gesture-based control interface that enables associates to manipulate digital assets by adding, deleting, transferring, or modifying them, as well as altering access provisioning for users. The gesture-based control system recognizes a wide range of gestures to ensure accurate and intuitive control, making the management process more efficient and user-friendly.

A key feature of the invention is the heatmap visualization module, which displays digital asset anomalies associated with user information security issues. These anomalies can include inadequate patch levels, outdated software versions, non-permissible software installations, antivirus status, software license expiration, and unauthorized server access. The heatmap provides real-time updates and interactive features for detailed anomaly analysis, helping associates to quickly identify and address potential security risks.

The system also includes a networking module that pairs spatial computing devices to form a local area network for interactive collaborative asset provisioning. This enables real-time communication and coordination among asset management associates, supporting secure and encrypted communication channels to protect sensitive data. By enabling multiple users to work together, the system ensures consistent and comprehensive asset management practices.

Another significant aspect of the invention is the user selection module, which allows asset management associates to select multiple users simultaneously for real-time asset provisioning. This feature streamlines the selection process with advanced filtering and sorting options, allowing for efficient and concurrent management of digital assets. This real-time capability ensures that the system can quickly adapt to changes in user roles and organizational needs.

The asset tagging module generates asset anchor tags and labels them to users for tracking and managing digital assets. This functionality ensures accurate tagging and easy retrieval of asset information, utilizing unique identifiers and metadata for comprehensive asset tracking. The spatial recognition module further enhances this by recognizing users' location spatial maps, including surroundings and geolocation. This enables the provisioning of digital assets until the asset management associate sees the user in a defined spatial map and geolocation in real-time, providing context-aware asset management.

The spatial scanning engine scans and identifies spatial information related to users and their environments, supporting high-resolution scanning and real-time data processing. This precise and detailed spatial data collection is crucial for the accuracy and efficiency of the system. Complementing this is the user asset extraction engine, which extracts detailed information about user digital assets. This engine interfaces with various asset management databases and systems to ensure comprehensive data extraction, providing up-to-date asset information.

The spatial anchor programming engine facilitates the management and organization of digital assets based on spatial anchors. This engine supports dynamic anchor adjustments and multi-anchor configurations, enhancing tracking accuracy. The asset orchestration engine manages the overall orchestration of digital assets according to organizational policies and procedures, incorporating machine learning algorithms to optimize asset allocation and utilization based on historical data and predictive analytics.

An asset anomaly event engine detects compliance issues related to digital asset management and generates alerts for asset management associates, enabling prompt corrective actions. This engine utilizes advanced anomaly detection techniques and customizable alert thresholds to ensure timely identification of potential issues. The asset management rule engine enforces organizational rules and policies related to digital asset management, allowing for the creation and modification of complex rule sets and integrating with other compliance management systems.

The gesture engine processes gesture-based inputs from asset management associates, enhancing user interaction and control over digital assets. This engine supports customizable gesture sets and provides feedback mechanisms to ensure accurate gesture recognition and execution. The asset deployment engine deploys digital assets to users based on real-time data and contextual information, integrating with workflow management systems to automate and streamline the deployment process.

The deep learning module analyzes large datasets to identify patterns and provide predictive insights for digital asset management. This module continuously updates its models based on new data, ensuring high accuracy and relevance of predictions. By improving decision-making and proactive management, the deep learning module allows the system to evolve and improve with changing needs and environments.

A visualization module on the spatial computing device visualizes compliance parameters and security risks through an intuitive user interface. This module provides interactive dashboards, customizable reports, and real-time data visualization tools to assist asset management associates in making informed decisions. This enhances the overall efficiency and effectiveness of digital asset management by providing clear and actionable insights.

In summary, this invention offers a comprehensive, real-time, and integrated approach to digital asset management. By leveraging advanced technologies such as LiDAR, gesture recognition, and augmented reality, the system provides an intuitive, interactive, and efficient solution for managing digital assets. The innovative features and robust components ensure efficient, secure, and effective management of digital assets, meeting the demands of modern organizations. The invention represents a significant advancement in digital asset management, providing organizations with the tools needed to manage their assets in a more efficient, secure, and responsive manner.

The description of various example embodiments herein is intended to achieve the goals previously outlined, referencing the illustrations included in this disclosure. These illustrations depict multiple systems and methods for implementing the disclosed information. It should be recognized that alternative implementations are possible, and modifications to both structure and functionality may be made. The description details various connections between elements, which should be interpreted broadly. Unless explicitly stated otherwise, these connections can be either direct or indirect and may be established through either wired or wireless methods. This document does not aim to restrict the nature of these connections.

Terms such as “computers,” “machines,” and similar phrases are used interchangeably based on the context to denote devices that may be general-purpose or specialized for specific functions, whether virtual or physical, and capable of network connectivity. This encompasses all pertinent hardware, software, and components known to those skilled in the field. Such devices might feature specialized circuits like application-specific integrated circuits (ASICs), microprocessors, cores, or other processing units for executing, accessing, controlling, or implementing various types of software, instructions, data, modules, processes, or routines. The employment of these terms within this document is not intended to restrict or exclusively refer to any specific type of electronic devices or components, and should be interpreted broadly by those with relevant expertise. For conciseness and assuming familiarity, detailed descriptions of computer/software components and machines are omitted.

Software, executable code, data, modules, procedures, and similar entities may reside on tangible, physical computer-readable storage devices. This includes a range from local memory to network-attached storage, and various other accessible memory types, whether removable, remote, cloud-based, or accessible through other means. These elements can be stored in both volatile and non-volatile memory forms and may operate under different conditions such as autonomously, on-demand, as per a preset schedule, spontaneously, proactively, or in response to certain triggers. They may be consolidated or distributed across multiple computers or devices, integrating their memory and other components. These elements can also be located or dispersed across network-accessible storage systems, within distributed databases, big data infrastructures, blockchains, or distributed ledger technologies, whether collectively or in distributed configurations.

The term “networks” and similar references encompass a wide array of communication systems, including local area networks (LANs), wide area networks (WANs), the Internet, cloud-based networks, and both wired and wireless configurations. This category also covers specialized networks such as digital subscriber line (DSL) networks, frame relay networks, asynchronous transfer mode (ATM) networks, and virtual private networks (VPN), which may be interconnected in various configurations. Networks are equipped with specific interfaces to facilitate diverse types of communications—internal, external, and administrative—and have the ability to assign virtual IP addresses (VIPs) as needed. Network architecture involves a suite of hardware and software components, including but not limited to access points, network adapters, buses, both wired and wireless ethernet adapters, firewalls, hubs, modems, routers, and switches, which may be situated within the network, on its edge, or externally. Software and executable instructions operate on these components to facilitate network functions. Moreover, networks support HTTPS and numerous other communication protocols, enabling them to handle packet-based data transmission and communications effectively.

As used herein, Generative Artificial Intelligence (AI) or the like refers to AI techniques that learn from a representation of training data and use it to generate new content similar to or inspired by existing data. Generated content may include human-like outputs such as natural language text, source code, images/videos, and audio samples. Generative AI solutions typically leverage open-source or vendor sourced (proprietary) models, and can be provisioned in many ways, including, but not limited to, Application Program Interfaces (APIs), websites, search engines, and chatbots. Most often, Generative AI solutions are powered by Large Language Models (LLMs) which were pre-trained on large datasets using deep learning with over 500 million parameters and reinforcement learning methods. Any usage of Generative AI and LLMs is preferably governed by an Enterprise AI Policy and an Enterprise Model Risk Policy.

Generative artificial intelligence models have been evolving rapidly, with various organizations developing their own versions. Sample generative AI models that can be used under various aspects of this disclosure include but are not limited to: (1) OpenAI GPT Models: (a) GPT-3: Known for its ability to generate human-like text, it's widely used in applications ranging from writing assistance to conversation. (b) GPT-4: An advanced version of the GPT series with improved language understanding and generation capabilities. (2) Meta (formerly Facebook) AI Models—Meta LLaMA (Language Model Meta AI): Designed to understand and generate human language, with a focus on diverse applications and efficiency. (3) Google AI Models: (a) BERT (Bidirectional Encoder Representations from Transformers): Primarily used for understanding the context of words in search queries. (b) T5 (Text-to-Text Transfer Transformer): A versatile model that converts all language problems into a text-to-text format. (4) DeepMind AI Models: (a) GPT-3.5: A model similar to GPT-3, but with further refinements and improvements. (b) AlphaFold: A specialized model for predicting protein structures, significant in biology and medicine. (5) NVIDIA AI Models—Megatron: A large, powerful transformer model designed for natural language processing tasks. (6) IBM AI Models—Watson: Known for its application in various fields for processing and analyzing large amounts of natural language data. (7) XLNet: An extension of the Transformer model, outperforming BERT in several benchmarks. (8) GROVER: Designed for detecting and generating news articles, useful in understanding media-related content. These models represent a range of applications and capabilities in generative AI. One or more of the foregoing may be used herein as desired. All are considered within the sphere and scope of this disclosure.

Generative AI and LLMs can be used in various parts of this disclosure performing one or more various tasks, as desired, including: (1) Natural Language Processing (NLP): This involves understanding, interpreting, and generating human language. (2) Data Analysis and Insight Generation: Including trend analysis, pattern recognition, and generating predictions and forecasts based on historical data. (3) Information Retrieval and Storage: Efficiently managing and accessing large data sets. (4) Software Development Lifecycle: Encompassing programming, application development, deployment, along with code testing and debugging. (5) Real-Time Processing: Handling tasks that require immediate processing and response. (6) Context-Sensitive Translations and Analysis: Providing accurate translations and analyses that consider the context of the situation. (7) Complex Query Handling: Utilizing chatbots and other tools to respond to intricate queries. (8) Data Management: Processing, searching, retrieving, and using large quantities of information effectively. (9) Data Classification: Categorizing and classifying data for better organization and analysis. (10) Feedback Learning: Processes whereby AI/LLMs improve performance based on feedback it receives. (Key aspects can include, for example, human feedback, Reinforcement Learning, interactive learning, iterative improvement, adaptation, etc.). (11) Context Determination: Identifying the relevant context in various scenarios. (12) Writing Assistance: Offering help in composing human-like text for various forms of writing. (13) Language Analysis: Analyzing language structures and semantics. (14) Comprehensive Search Capabilities: Performing detailed and extensive searches across vast data sets. (15) Question Answering: Providing accurate answers to user queries. (16) Sentiment Analysis: Analyzing and interpreting emotions or opinions from text. (17) Decision-Making Support: Providing insights that aid in making informed decisions. (18) Information Summarization: Condensing information into concise summaries. (19) Creative Content Generation: Producing original and imaginative content. (20) Language Translation: Converting text or speech from one language to another.

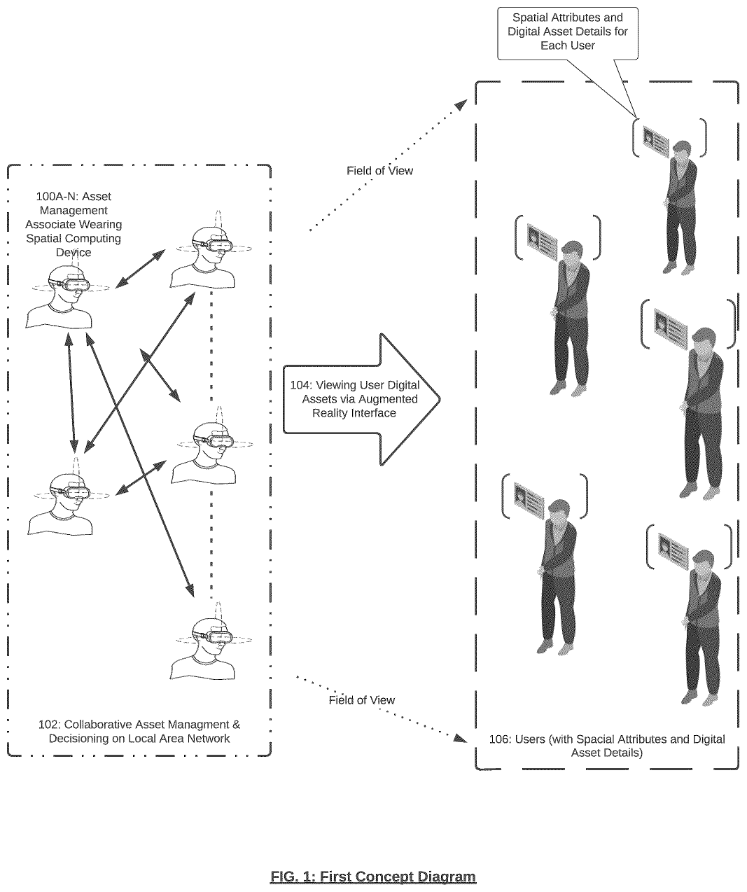

FIG. 1 provides an intricate and detailed depiction of a system designed for collaborative asset management utilizing advanced spatial computing devices. The primary elements of the diagram are the asset management associates, denoted by 100A-N, each of whom is equipped with a spatial computing device. These devices serve as critical tools in the associates' workflow, enabling them to manage, orchestrate, and make decisions regarding user digital assets in real-time.

The spatial computing devices provide an augmented reality interface, marked by 104, which allows the associates to visualize and interact with digital assets directly within their field of view. This interface is not just a display but an interactive platform where associates can engage with the digital representations of assets. The assets, their spatial attributes, and their detailed information are overlaid within the physical workspace of the associates, ensuring that all relevant data is accessible and actionable at a glance.

One of the critical features illustrated is the collaborative nature of the system, supported by a local area network (LAN), represented by 102. This network facilitates seamless and secure communication between multiple asset management associates. It allows them to share information, coordinate their actions, and collaborate on asset management tasks in real-time. This collaborative capability is essential for ensuring that asset management practices are unified and efficient, particularly in large organizations where multiple associates must work together to manage a vast array of assets.

In addition to displaying digital assets, the spatial computing devices are equipped to show spatial attributes and digital asset details for each user, denoted by 106. These details are crucial for making informed decisions about asset management. The devices capture and display comprehensive data, including the location, usage, status, and access permissions of each asset. This detailed information allows associates to track assets accurately, identify potential issues, and ensure compliance with organizational policies.

The augmented reality interface (104) is designed to support a range of interactive functions. Associates can use gesture-based controls to manipulate digital assets within the interface. These controls enable them to add, delete, transfer, or modify assets with simple, intuitive gestures. For example, an associate can swipe to transfer an asset from one user to another, tap to open detailed information about an asset, or pinch to zoom in on specific data. This interactive approach reduces the need for traditional input devices like keyboards and mice, streamlining the workflow and making the management process more efficient and user-friendly.

The diagram also emphasizes the importance of real-time collaboration and decision-making. The local area network (102) not only facilitates communication but also supports collaborative asset management activities. Multiple associates can work together on asset provisioning, anomaly detection, and compliance enforcement, sharing insights and strategies to enhance the overall effectiveness of the management process.

The inclusion of users, indicated by 106, with their spatial attributes and digital asset details, further enriches the system's functionality. Each user's data is accessible by the spatial computing devices, providing a holistic view of the asset landscape. This integration ensures that all asset management activities are context-aware, taking into account the specific needs and environments of each user. For instance, the system can identify which assets are being used in a particular location, highlight assets that are due for maintenance, or flag assets that do not comply with security policies.

Additionally, the spatial computing devices are equipped with advanced sensors and data processing capabilities to enhance their functionality. These devices can capture real-time spatial data, process it to extract valuable insights, and present it in an easily understandable format. This capability is particularly useful for identifying spatial patterns, detecting anomalies, and making proactive decisions to mitigate risks.

In conclusion, FIG. 1 represents a sophisticated system for collaborative asset management that leverages the power of spatial computing devices and augmented reality interfaces. By providing real-time, interactive, and context-aware tools, the system enhances the ability of asset management associates, both individually and working together collaboratively, to manage digital assets effectively for myriad users. The integration of spatial attributes, detailed asset information, and collaborative capabilities ensures that asset management practices are efficient, secure, and aligned with organizational goals. This innovative approach marks a significant advancement in the field of digital asset management, offering a robust solution to the challenges faced by modern organizations.

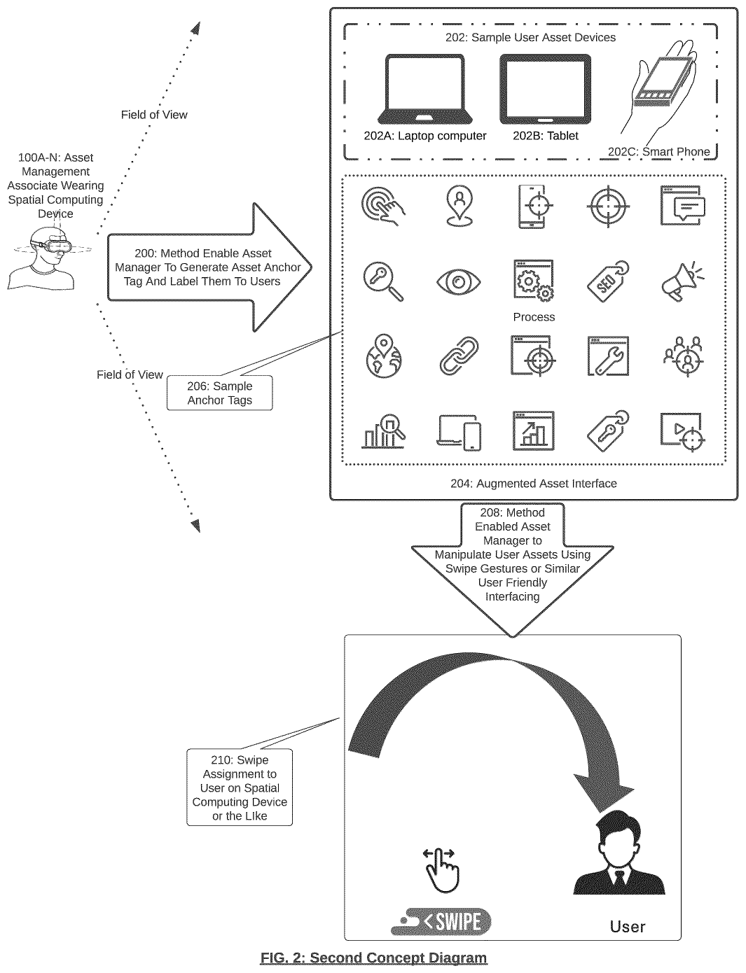

FIG. 2 presents a detailed concept diagram that illustrates a sophisticated method for enabling asset managers to generate tags and labels for digital assets using a spatial computing device. Central to this process are asset management associate(s) (100A-N), who utilizes spatial computing device(s) to interact with and manage digital assets effectively. This device, which integrates augmented reality and gesture-based controls, transforms the asset management process, making it more intuitive, dynamic, and responsive.

The method (200) begins with the asset management associate generating tags and labels for digital assets. This foundational step is critical as it sets up a systematic way to organize and track digital assets accurately, ensuring that every asset is uniquely identified and easily retrievable. The spatial computing device provides an augmented asset interface (204) that displays digital assets within the associate's field of view, allowing for real-time interaction and management of these assets. This interface enhances the management experience by providing a comprehensive view of all assets and their spatial attributes.

One of the standout features of this system is its support for swipe gestures (210). The swipe assignment functionality allows the asset management associate(s) to allocate digital assets to user(s) through simple, intuitive gestures. By swiping on the device's interface, the associate(s) can quickly and efficiently assign assets to user(s), significantly reducing the time and effort typically required for such tasks. This user-friendly interface ensures that the process is not only efficient but also minimizes the likelihood of errors, thereby enhancing the overall effectiveness of asset management.

In addition to generating tags and labels, the spatial computing device enables the asset management associate to manipulate user assets through gesture-based controls (208). These controls are designed to be user-friendly, allowing the associate to add, delete, transfer, or modify digital assets seamlessly. The augmented asset interface (204) ensures that these interactions are straightforward and intuitive, making it easier for the associate to manage assets without extensive training. The interface leverages the latest advancements in user experience and augmented reality to provide a smooth and efficient workflow.

The method also incorporates advanced features that enhance collaboration among asset management associates. The spatial computing device supports the formation of a local area network (LAN), enabling multiple asset management associates to work together in real-time. This collaborative environment is essential for ensuring that asset management practices are consistent and comprehensive across the organization. The networking module within the spatial computing device facilitates secure and encrypted communication channels, protecting sensitive data while enabling efficient coordination and communication among associates.

A crucial component of the system is its spatial scanning engine, which scans and identifies spatial information related to users and their environments. This engine ensures precise and detailed spatial data collection, which is fundamental for the accuracy and efficiency of the system. Complementing this is the user asset extraction engine, which extracts detailed information about user digital assets from various asset management databases and systems. This comprehensive data extraction ensures that the asset management associate has access to up-to-date and accurate asset information, enabling informed decision-making.

The spatial anchor programming engine plays a vital role in managing and organizing digital assets based on spatial anchors. This engine supports dynamic anchor adjustments and multi-anchor configurations, enhancing tracking accuracy and making the management process more flexible and robust. The asset orchestration engine oversees the overall orchestration of digital assets according to organizational policies and procedures. It incorporates machine learning algorithms to optimize asset allocation and utilization based on historical data and predictive analytics, ensuring that asset management practices are both efficient and compliant.

Another key feature of the system is the asset anomaly event engine, which detects compliance issues related to digital asset management and generates alerts for asset management associates. This engine employs advanced anomaly detection techniques and customizable alert thresholds to ensure the timely identification of potential issues, enabling prompt corrective actions. The asset management rule engine enforces organizational rules and policies related to asset management, allowing for the creation and modification of complex rule sets. This engine integrates with other compliance management systems to maintain consistent and secure asset management practices.

The gesture engine enhances user interaction and control over digital assets by processing gesture-based inputs from asset management associates. This engine supports customizable gesture sets and provides feedback mechanisms to ensure accurate gesture recognition and execution, making the management process more intuitive. The asset deployment engine manages the deployment of digital assets to users based on real-time data and contextual information. This engine integrates with workflow management systems to automate and streamline the deployment process, ensuring that digital assets are provisioned timely and accurately.

Additionally, the system features a deep learning module that analyzes large datasets to identify patterns and provide predictive insights for digital asset management. This module continuously updates its models based on new data, ensuring high accuracy and relevance of predictions. By improving decision-making and proactive management, the deep learning module allows the system to evolve and improve with changing needs and environments.

The visualization module on the spatial computing device is another innovative aspect of the system. This module visualizes compliance parameters and security risks through an intuitive user interface, providing interactive dashboards, customizable reports, and real-time data visualization tools. These visual aids assist asset management associates in making informed decisions, enhancing the overall efficiency and effectiveness of digital asset management.

Overall, FIG. 2 depicts a comprehensive method for managing digital assets using spatial computing devices. It highlights the integration of advanced features such as LiDAR face detection, gesture-based controls, heatmap visualizations, and real-time collaborative capabilities, all designed to streamline and secure the asset management process. The system provides a robust, intuitive, and efficient solution for managing digital assets in modern organizations, representing a significant advancement in the field. This method enhances the precision, security, and efficiency of digital asset management, making it a vital tool for contemporary organizations.

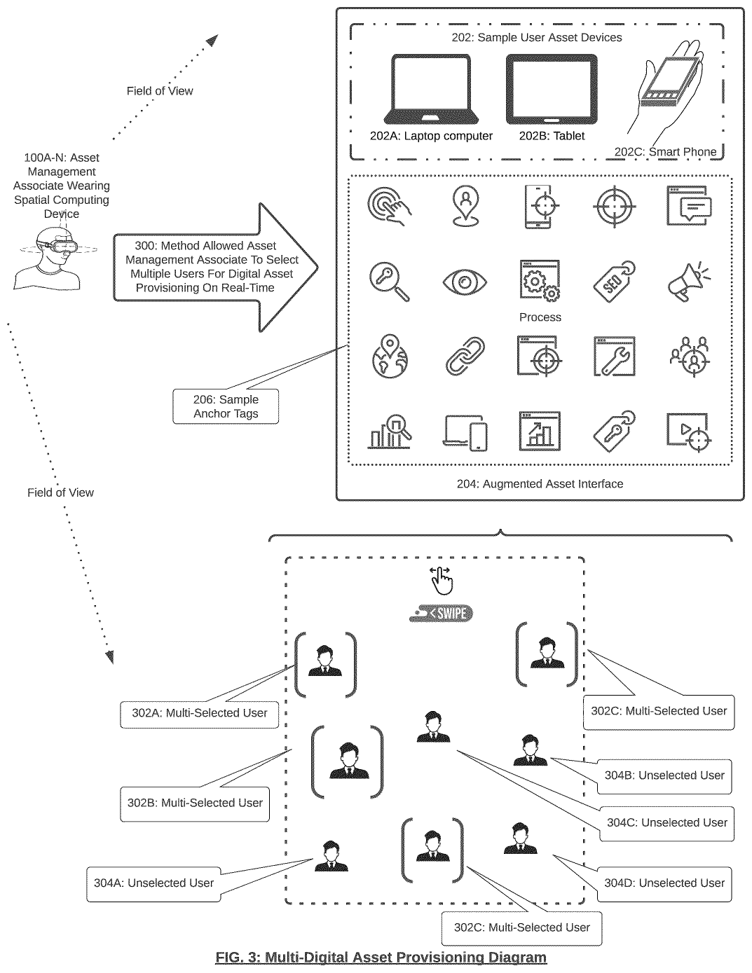

FIG. 3 illustrates a sophisticated system for multi-digital asset provisioning using spatial computing devices. This system enables an asset management associate to select multiple users for digital asset provisioning in real-time. The figure includes several key elements and steps that collectively describe the process in great detail.

At the core of the system is method 300, which is specifically designed to allow an asset management associate to select multiple users for digital asset provisioning simultaneously. The process begins with the asset management associate wearing a spatial computing device, which displays the augmented asset interface 204. This interface overlays digital information onto the associate's physical environment, providing a comprehensive view of users and their associated digital assets. The augmented asset interface 204 is central to the system as it shows sample anchor tags (206) that can be assigned to various user asset devices (202). These user asset devices include a range of common digital tools such as, for example, laptop computers, tablets, and smartphones. Specifically, 202a represents a laptop computer, 202b represents a tablet, and 202c represents a smartphone. Each of these devices can require different types of digital asset provisioning, such as software installations, access rights, and security updates.

Within this interface, users are represented in two distinct states: selected and unselected. Selected users, denoted as 302B and 302C, have been chosen by the asset management associate(s) for digital asset provisioning or management. These selected users are highlighted within the interface, indicating their status and readiness for provisioning or management. On the other hand, unselected users, represented by 304A, 304B, 304C, and 304D, have not been chosen for provisioning or management at this stage. Their status may be indicated by their lack of highlighting, allowing the asset management associate to easily differentiate between those who need provisioning and those who do not.

The system includes a crucial component for real-time data processing (206), which ensures that any changes in user selection are instantly reflected in the interface. This dynamic updating capability is essential for maintaining the accuracy and efficiency of the asset management process. The real-time processing allows the asset management associate to see immediate feedback from their actions, reducing the potential for errors and ensuring that all digital assets are provisioned correctly and promptly.

The augmented asset interface 204 provides a dynamic and interactive user experience. It supports the selection of multiple users and displays both selected and unselected users clearly, allowing the associate to manage the provisioning process efficiently. The interface is designed to be highly intuitive, leveraging advanced features such as gesture-based controls. The associate can use simple gestures to interact with digital assets and user information, making the process more streamlined and less prone to error. For instance, swiping motions can be used to select or deselect users, tapping can open detailed information about an asset, and pinching gestures can zoom in on specific data.

In addition to these user-friendly controls, the augmented asset interface can display heatmaps that highlight areas of concern. These heatmaps can show users with outdated software, non-compliant installations, or other security issues, helping the associate quickly identify and address potential problems. This visualization tool is particularly useful in large organizations where managing numerous digital assets can become overwhelming. By providing a clear and intuitive overview, the heatmaps assist in maintaining the security and compliance of all digital assets.

The spatial recognition capabilities of the device further enhance its functionality. The device can recognize the spatial properties and geolocation of users, ensuring that assets are provisioned accurately based on the user's location and context. This feature is particularly important in environments where users and their devices move frequently, as it ensures that the right assets are always provisioned to the correct users.

Compliance monitoring is another critical aspect of the system. It continuously monitors various compliance parameters and alerts the associate to any issues, such as expired licenses or unauthorized access. This ongoing monitoring helps maintain the integrity and security of the organization's digital assets, ensuring that all provisioning activities adhere to established policies and regulations.

The system also supports collaborative provisioning, allowing multiple associates to work together in real-time. The spatial computing device connects to a local area network (LAN), facilitating secure and efficient communication among multiple asset management associates. This collaborative environment ensures that asset management practices are consistent and comprehensive across the organization. By enabling real-time communication and coordination, the system ensures that all associates are on the same page, reducing the likelihood of errors and improving overall efficiency.

Overall, FIG. 3 provides a detailed depiction of a multi-digital asset provisioning system that leverages spatial computing and augmented reality to enhance the efficiency and accuracy of digital asset management. By incorporating elements such as sample user asset devices (202, 202a, 202b, 202c), sample anchor tags (206), and the augmented asset interface (204), the system ensures that asset management associates can manage and provision digital assets accurately and efficiently, meeting the demands of modern organizations. The integration of real-time data processing, gesture-based controls, heatmap visualizations, spatial recognition, and compliance monitoring creates a robust and intuitive system that significantly improves the digital asset management process.

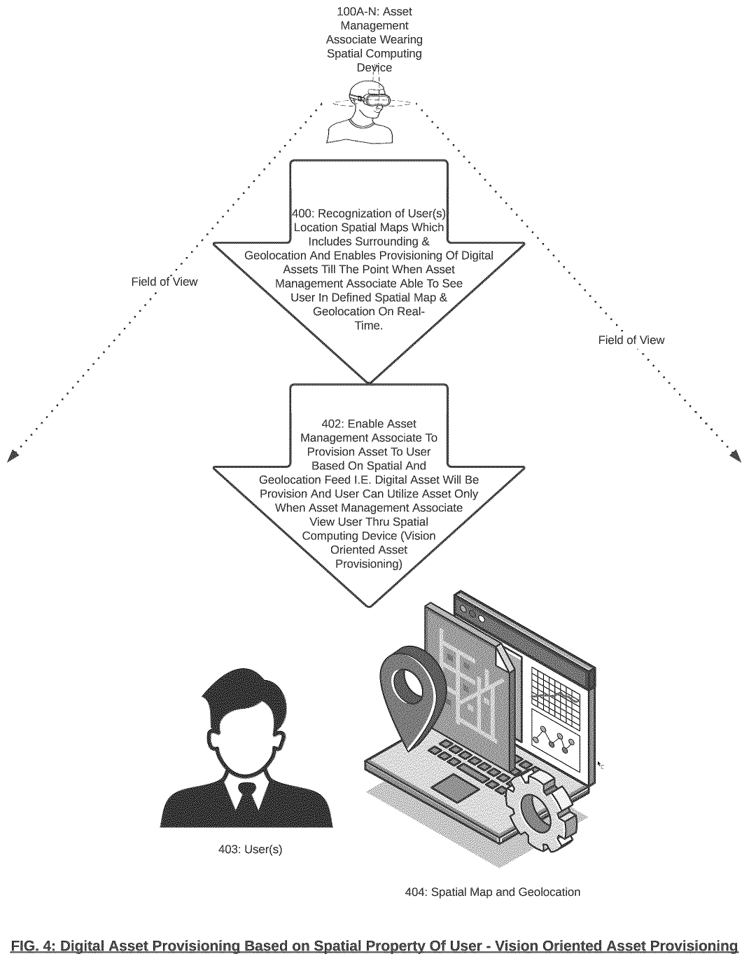

In FIG. 4, the digital asset provisioning system based on spatial properties is meticulously designed to ensure that digital assets are managed efficiently and securely through a spatial computing device. The process initiates with step 400, which involves the recognition of users' locations through spatial maps. This step utilizes advanced spatial computing technologies to generate real-time maps of the users' surroundings, enriched with geolocation data to pinpoint the exact location of each user within the environment. This geospatial information forms the foundation for the subsequent steps in the asset provisioning process, allowing the system to create a comprehensive and dynamic spatial map that includes all relevant spatial information and geolocations of the users.

Step 402 focuses on enabling the asset management associate to provision digital assets to users based on the real-time spatial and geolocation feed. This ensures that digital assets are only provisioned when the asset management associate can visually confirm the user's presence within the defined spatial map. The spatial computing device, equipped with augmented reality (AR) and possibly LiDAR (Light Detection and Ranging) technology, allows the associate to see a live feed of the user's location, providing real-time visual confirmation that is crucial for security purposes. This setup ensures that assets are only deployed to authorized and correctly identified users.

The users, denoted by 403, are dynamically mapped within the system, with their locations constantly updated to reflect their movements within the spatial environment. This continuous tracking ensures that the system can provide accurate and timely provisioning of assets tailored to the current location and spatial context of each user. The spatial map and geolocation functionality, indicated by 404, are integral to the system's operation. The spatial map is a real-time, interactive map that updates as users move, and it includes detailed geolocation data essential for precise asset provisioning. This functionality ensures that the system knows the exact position of each user within the spatial environment, maintaining high accuracy to prevent unauthorized access and ensure that digital assets are only accessible to users within the designated spatial parameters.

The spatial computing device used by the asset management associate likely incorporates a combination of AR and LiDAR technologies. AR overlays digital information onto the real-world environment, allowing the associate to interact with digital assets as if they were part of the physical world. LiDAR provides highly accurate spatial measurements by emitting laser beams and measuring the time it takes for them to bounce back from objects, which is instrumental in creating detailed spatial maps and ensuring precise geolocation tracking.

The system's architecture includes several sophisticated components that work together to ensure efficient and secure asset provisioning. The spatial scanning engine scans the environment to collect spatial data, using sensors to detect objects and users within the space and creating a detailed map of the environment. The user asset extraction engine extracts detailed information about each user's digital assets, including software licenses, access permissions, and hardware components, integrating this information with the spatial map to provide a comprehensive view of the user's assets. The spatial anchor programming engine creates spatial anchors, which are virtual markers placed within the environment to help in tagging and tracking digital assets, ensuring they are provisioned to the correct location. The asset orchestration engine manages the overall process of digital asset provisioning, ensuring compliance with organizational policies and optimizing the allocation of assets based on real-time data. The gesture engine processes gesture-based inputs from the asset management associate, allowing interaction with the system using intuitive gestures, which makes the process of asset provisioning more efficient. The asset deployment engine handles the actual deployment of digital assets to users, ensuring that assets are provisioned based on real-time spatial and geolocation data, thus maintaining accuracy and security.

The system also includes advanced visualization tools, such as heatmap visualizations, to help asset management associates quickly identify and address any anomalies or security issues. These tools provide a clear and intuitive overview of the digital asset landscape, highlighting areas that require immediate attention. In summary, FIG. 4 describes a highly sophisticated system for digital asset provisioning based on spatial properties and geolocation data. The system leverages advanced spatial computing technologies to ensure that digital assets are managed securely and efficiently, providing real-time visual confirmation of users' locations and dynamically updating spatial maps. This ensures that assets are only provisioned to authorized users within the defined spatial parameters, enhancing both security and efficiency in digital asset management.

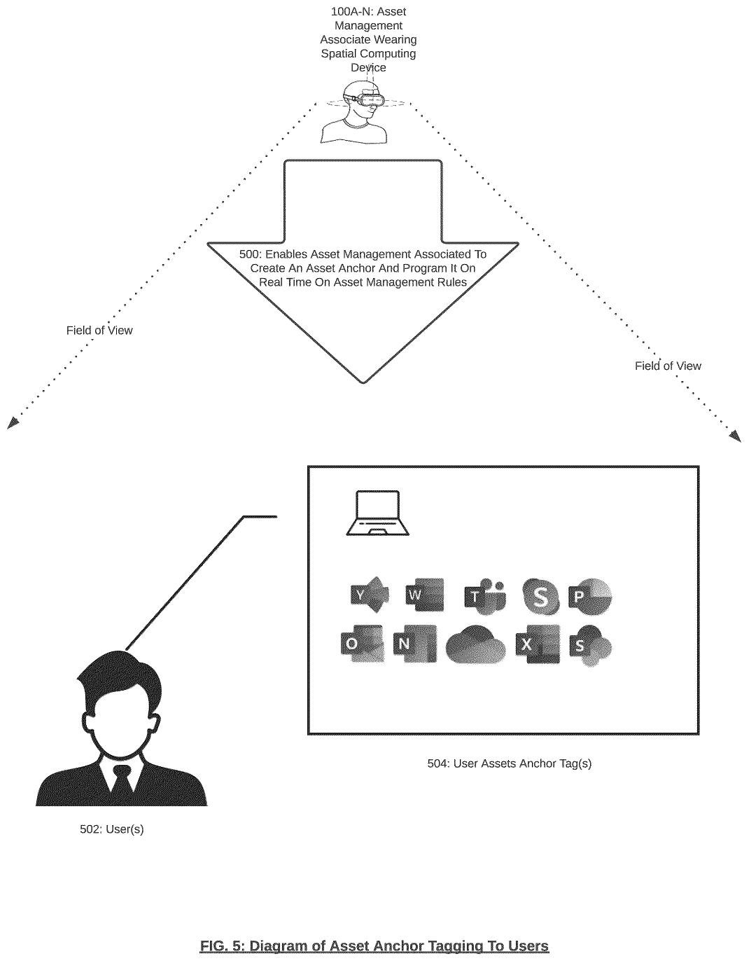

In FIG. 5, the system depicted facilitates a sophisticated method for managing digital assets using a spatial computing device, where asset management is conducted in real-time by creating asset anchors and programming them based on established asset management rules. The central process begins with step 500, which is pivotal as it signifies the initiation of the asset management cycle by the asset management associate.

Step 500 involves the asset management associate utilizing a spatial computing device to establish an asset anchor. An asset anchor is a virtual marker that is associated with a specific asset within the user's environment. This process is dynamic and interactive, allowing for the asset anchor to be created and programmed on the fly. This capability ensures that asset management rules, such as those related to compliance, security, and usage, are applied in real-time.

Users 502 represent the individuals who are associated with the digital assets and the spatial computing device. These users are integral to the system as they possess various digital assets that need to be effectively managed. The spatial computing device provides an augmented reality (AR) interface, which overlays digital information onto the users' physical environment. This AR interface allows asset management associates and/or users to view, manage, and interact with their digital assets seamlessly within their field of view (FOV). This visual and interactive integration enhances user engagement and facilitates more efficient asset management practices.

User assets anchor tags 504 are critical components of the system. These anchor tags are virtual markers created and assigned to specific digital assets. Each tag is programmed with specific asset management rules that govern how the asset should be handled, ensuring compliance with organizational policies and enhancing security. The anchor tags serve multiple purposes: they identify the asset, provide contextual information, and track the asset's status and location in real-time. This tagging system ensures that each asset is uniquely identifiable and that its management adheres to the predefined rules set by the organization.

The detailed description of FIG. 5 highlights several key features and benefits of the system. The use of spatial computing devices allows for real-time interaction with digital assets, making asset management processes dynamic and efficient. The system's ability to create and program asset anchors on the fly means that asset tracking and management are continuously updated, providing real-time information to asset management associates. This real-time capability is crucial for maintaining the integrity and security of digital assets, especially in environments where assets are frequently moved, used, or reallocated.

Furthermore, the spatial computing device leverages advanced technologies such as augmented reality and gesture recognition to provide an intuitive and user-friendly interface. Users and asset management associates can interact with digital assets using simple gestures, such as swiping, tapping, or pinching. These gestures allow for actions like adding, deleting, transferring, or modifying assets to be performed quickly and efficiently. The intuitive nature of these controls reduces the need for extensive training, making the system accessible to a broader range of users.

In addition to real-time interaction and intuitive controls, the system includes features that enhance collaboration among asset management associates. The spatial computing device can connect to a local area network (LAN), enabling secure and efficient communication between multiple associates. This collaborative capability ensures that asset management practices are consistent and comprehensive across the organization. Multiple associates can work together to manage assets, share insights, and coordinate their actions, enhancing the overall effectiveness of asset management.

The system also includes advanced visualization tools, such as heatmaps, to help asset management associates quickly identify and address potential security risks. These visualizations provide a clear and intuitive overview of the digital asset landscape, highlighting areas that require immediate attention. For example, the heatmap might show assets that are out of compliance, such as those with outdated software, inadequate patch levels, or unauthorized installations. By providing this level of detail, the system helps ensure that all digital assets comply with organizational policies and security standards.

Overall, FIG. 5 represents a significant advancement in digital asset management. By integrating real-time interaction, advanced visualization, intuitive controls, and collaborative capabilities, the system provides a robust, efficient, and secure solution for managing digital assets. This approach not only enhances the efficiency and accuracy of asset management practices but also ensures that digital assets are managed in a manner that aligns with the dynamic and evolving needs of modern organizations. The system's innovative features and comprehensive approach to asset management make it an indispensable tool for contemporary digital asset management.

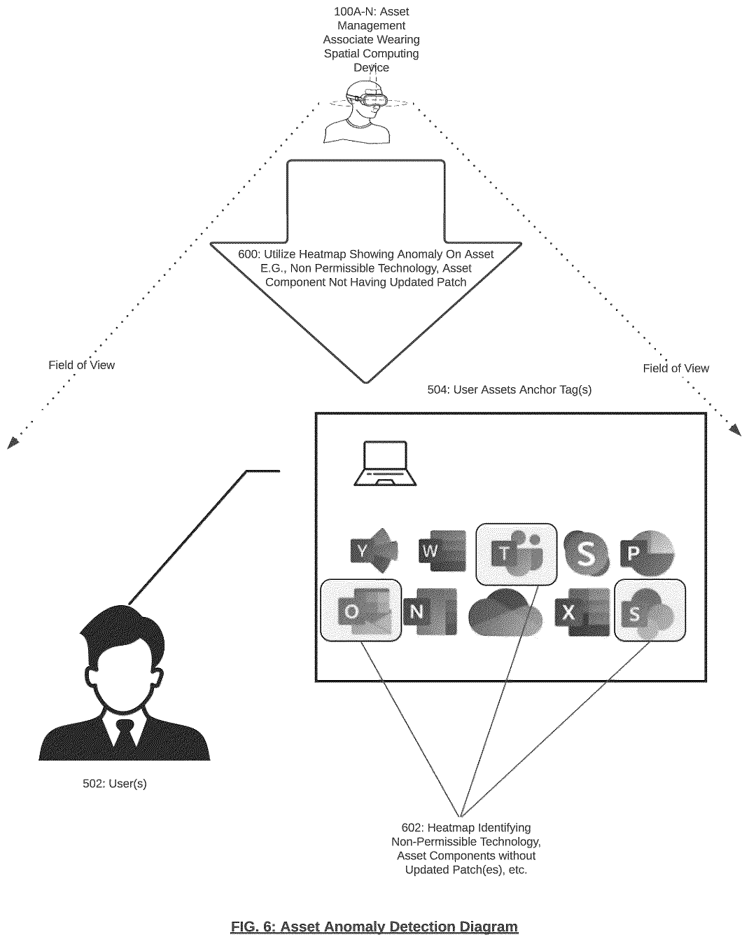

FIG. 6 presents an asset anomaly detection system that leverages advanced spatial computing and augmented reality (AR) technologies to provide a comprehensive real-time solution for digital asset management. This system is crucial for identifying, monitoring, and managing anomalies related to user assets within an organization.

The process begins at step 600, which involves the use of a heatmap to show anomalies on assets. This step is central to the system's functionality, as the heatmap serves as a visual tool for highlighting potential issues with user assets. The anomalies displayed on the heatmap can include non-permissible technologies, asset components that lack necessary updates, outdated software versions, non-compliant software installations, antivirus status, software license expiration, and unauthorized server access.

The users, represented by reference number 502, are associated with their assets. These users are typically employees or associates within an organization who have been provisioned with various digital and physical assets necessary for their roles.

The spatial computing device(s) 100A-N, which may include AR interfaces and LiDAR technology, provides real-time data and visualizations of these assets, enabling efficient and dynamic asset management. User assets are tagged with anchor tags, denoted by reference number 504. These anchor tags are virtual markers that are programmed with specific asset management rules to ensure compliance and security with various applications or other devices or items. Each tag uniquely identifies an asset, providing contextual information and tracking its status and location in real-time. This tagging system is integral to the management process, as it allows asset management associates to monitor and manage assets accurately and effectively.

The heatmap, labeled 602, is a crucial feature of this system. It visually represents the anomalies detected on user assets, making it easier for asset management associates to identify and address potential security risks. The heatmap's intuitive design ensures that even complex data can be quickly understood and acted upon. For example, the heatmap might display different colors to indicate the severity of an anomaly, with red representing critical issues such as non-permissible technology or missing security patches, and yellow indicating less severe issues like upcoming software license expiration.

The system's advanced technologies, such as LiDAR and AR, play a significant role in enhancing the accuracy and efficiency of asset management. LiDAR technology, which uses laser beams to measure distances and create detailed spatial maps, ensures precise user identification and asset tracking. This technology allows the spatial computing device to capture and process real-time spatial data, providing asset management associates with an accurate and comprehensive view of the asset landscape.

The spatial computing device facilitates the manipulation of digital assets through gesture-based controls. This feature allows asset management associates to perform various actions on digital assets, such as adding, deleting, transferring, or modifying them, using simple gestures. These intuitive controls reduce the need for traditional input devices like keyboards and mice, streamlining the asset management process and making it more user-friendly.

Additionally, the system supports collaborative asset management practices. The spatial computing device can connect to a local area network (LAN), enabling multiple asset management associates to work together in real-time. This collaborative capability ensures that asset management practices are consistent and comprehensive across the organization. By facilitating secure and efficient communication, the system allows associates to share insights, coordinate their actions, and address anomalies more effectively.

The integration of advanced visualization tools, such as the heatmap, enhances the system's overall functionality. These tools provide a clear and intuitive overview of the digital asset landscape, highlighting areas that require immediate attention. For example, the heatmap might show clusters of assets with similar issues, allowing asset management associates to prioritize their efforts and address the most critical problems first. This proactive approach to asset management helps maintain the security and compliance of all digital assets within the organization.

Furthermore, the system incorporates machine learning and predictive analytics to continuously improve its performance. By analyzing historical data and identifying patterns, the system can anticipate potential issues and provide predictive insights to asset management associates. This capability enables a proactive approach to asset management, allowing associates to address vulnerabilities before they become significant problems.

In summary, FIG. 6 illustrates a sophisticated asset anomaly detection system that leverages spatial computing and AR technologies to provide a comprehensive real-time solution for digital asset management. By utilizing a heatmap to visually represent anomalies, the system enhances the ability of asset management associates to identify and address potential security risks. The integration of advanced technologies, intuitive controls, and collaborative capabilities ensures that digital assets are managed efficiently, securely, and in compliance with organizational policies. This innovative approach represents a significant advancement in the field of digital asset management, providing organizations with the tools they need to effectively manage and secure their digital assets in a dynamic and ever-evolving landscape.

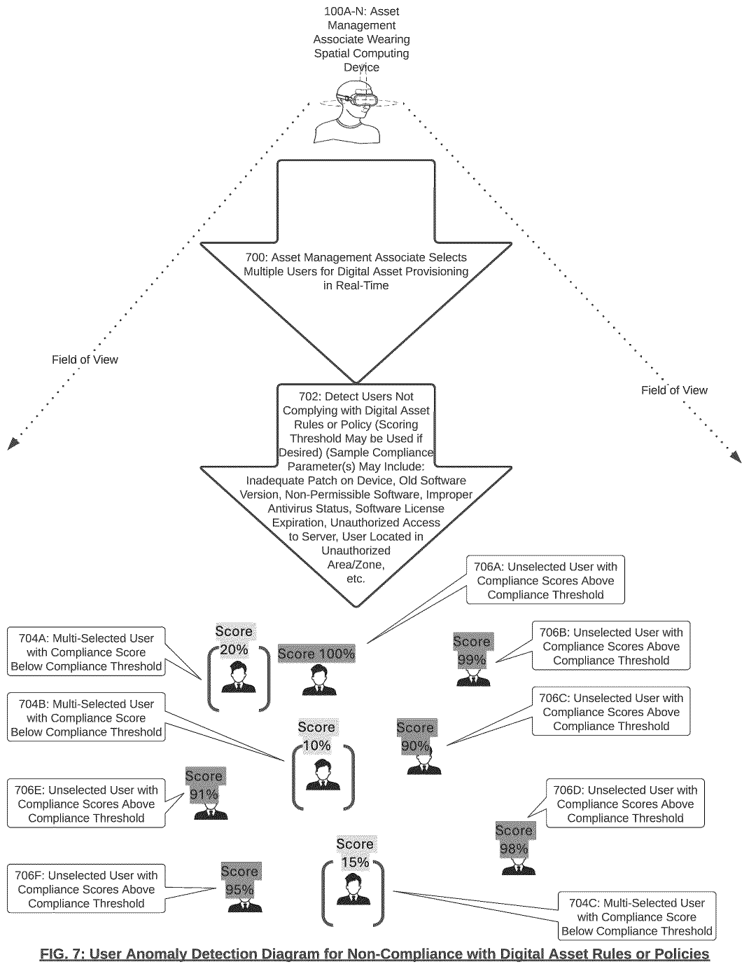

FIG. 7 presents an intricate and comprehensive depiction of a system designed for detecting user anomalies related to non-compliance with digital asset rules or policies. This system is integral to ensuring that all digital assets within an organization are managed according to established security protocols and compliance standards. The process is initiated by an asset management associate who is equipped with a spatial computing device, which significantly enhances their ability to monitor and manage digital assets in real-time.

Step 700 marks the beginning of this process, where the asset management associate selects multiple users for digital asset provisioning. This selection is done in real-time, leveraging the advanced capabilities of the spatial computing device. The device provides a highly interactive augmented reality (AR) interface, allowing the associate to visualize user data and make informed decisions about asset provisioning. This initial selection is crucial as it sets the stage for identifying and managing users who may be non-compliant with digital asset policies.

In step 702, the system detects users who are not complying with digital asset rules or policies. This detection process is underpinned by a scoring mechanism that evaluates various compliance parameters. These parameters include inadequate patch levels on devices, outdated software versions, the presence of non-permissible software, improper antivirus status, software license expiration, and unauthorized access to servers. Each parameter is associated with a specific compliance score, which collectively determines whether a user is compliant or non-compliant with the organization's digital asset policies. The system's ability to evaluate these parameters in real-time ensures that any non-compliance is promptly identified, allowing for immediate corrective actions.

Within the spatial computing device's field of view, users are visually categorized based on their compliance scores. Users 704A, 704B, and 704C are multi-selected users with compliance scores below the compliance threshold. This indicates that these users are not adhering to the established digital asset rules or policies and have been specifically selected by the asset management associate for further management. These users require immediate attention to address their non-compliance issues. On the other hand, users 706A, 706B, 706C, 706D, 706E, and 706F are unselected users with compliance scores above the compliance threshold, indicating that they are currently in compliance with the digital asset rules or policies and do not require immediate intervention.

The AR interface of the spatial computing device provides an immersive and intuitive user experience. It overlays digital information onto the physical environment, allowing the asset management associate to see detailed compliance information about each user directly within their field of view. This real-time visualization capability is crucial for effective digital asset management, as it enables the associate to quickly identify non-compliant users and take appropriate actions. For instance, the associate can use gesture-based controls to interact with the digital assets of non-compliant users, such as applying necessary software patches, updating outdated software, removing non-permissible software, renewing software licenses, or restricting access to unauthorized areas.

The system's advanced capabilities are further highlighted by its use of heatmap visualizations. These heatmaps provide a visual representation of compliance across the user base, highlighting areas of concern with color-coded indicators. For example, users with severe compliance issues might be marked in red, while those with minor issues might be marked in yellow. This visual tool helps the asset management associate quickly prioritize their actions, focusing first on the most critical compliance issues.

In addition to visualizing compliance data, the spatial computing device supports real-time data processing, ensuring that any changes in user compliance status are immediately reflected in the AR interface. This dynamic updating capability is essential for maintaining the accuracy and efficiency of the asset management process. It ensures that the asset management associate always has access to the most current information, allowing for timely and effective decision-making.

The gesture-based controls of the spatial computing device enhance the user experience by providing a natural and intuitive way to interact with digital assets. The associate can use simple gestures, such as swiping, tapping, or pinching, to perform various actions on digital assets. For example, a swiping gesture can be used to select or deselect users, a tapping gesture can open detailed information about a specific asset, and a pinching gesture can zoom in on a particular area of the heatmap. These intuitive controls reduce the need for traditional input devices, such as keyboards and mice, making the asset management process more streamlined and efficient.

The collaborative capabilities of the system further enhance its effectiveness. The spatial computing device can connect to a local area network (LAN), allowing multiple asset management associates to work together in real-time. This collaborative environment ensures that asset management practices are consistent and comprehensive across the organization. Multiple associates can share insights, coordinate their actions, and collectively address compliance issues, improving the overall efficiency and effectiveness of the asset management process.

The system also incorporates advanced security features to protect sensitive data. For instance, it may use homomorphic encryption to ensure that data transmitted within the system remains secure. This encryption method allows computations to be performed on encrypted data without needing to decrypt it first, significantly enhancing the system's overall data security. Additionally, the system may include biometric authentication to ensure that only authorized personnel can access and manage digital assets.

In summary, FIG. 7 depicts a sophisticated user anomaly detection system that leverages advanced spatial computing and AR technologies to provide a comprehensive, real-time solution for managing digital assets. By integrating real-time data processing, heatmap visualizations, gesture-based controls, and collaborative capabilities, the system enhances the efficiency, security, and accuracy of digital asset management practices. This innovative approach ensures that all digital assets comply with the organization's security policies and protocols, representing a significant advancement in the field of digital asset management.

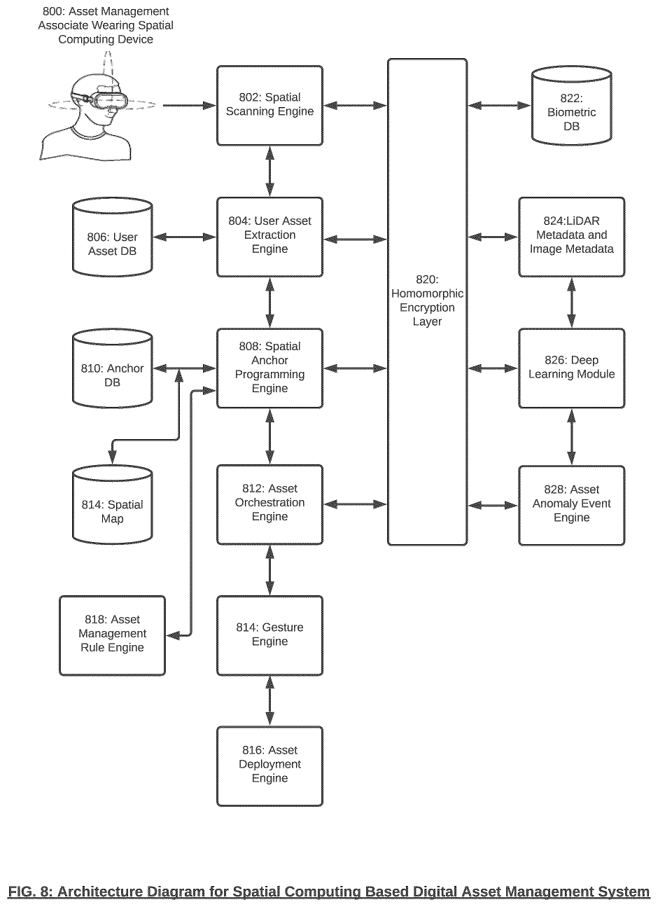

FIG. 8 presents a detailed architecture diagram for a spatial computing-based digital asset management system, emphasizing the intricate interactions and functionalities of various components to deliver a comprehensive solution for managing digital assets. Central to this architecture is the asset management associate (800), depicted as wearing a spatial computing device (802). This device is crucial for performing numerous asset management tasks, facilitating real-time interaction and decision-making within the user's field of view (804).

The system starts with the spatial scanning engine (802), a sophisticated module responsible for scanning and identifying spatial information related to users and their environments. This engine ensures the collection of precise and detailed spatial data, forming the foundation of the system's accuracy and efficiency. The spatial scanning engine's data collection capabilities are complemented by the user asset extraction engine (804). This engine is tasked with extracting detailed information about user digital assets, interfacing seamlessly with various asset management databases and systems to provide comprehensive and current asset information.

Supporting these extraction and scanning engines is the user asset database (806), which acts as a repository for the detailed information gathered about digital assets. This database ensures that all asset-related data is stored systematically, making it readily accessible for subsequent management and orchestration processes.

One of the pivotal components of this system is the spatial anchor programming engine (808). This engine facilitates the management and organization of digital assets by creating and managing spatial anchors. It supports dynamic anchor adjustments and multi-anchor configurations, enhancing the accuracy of asset tracking and providing flexibility in the management process. The data related to these spatial anchors is stored in the anchor database (810), ensuring all anchors are accurately recorded and easily retrievable when needed for asset tracking and management.

The asset orchestration engine (812) plays a central role in the overall management of digital assets, ensuring that all activities adhere to organizational policies and procedures. It leverages machine learning algorithms to optimize asset allocation and utilization, drawing on historical data and predictive analytics to make informed decisions. This engine is complemented by the gesture engine (814), which processes gesture-based inputs from the asset management associate (800). This engine enhances user interaction and control over digital assets, supporting customizable gesture sets and providing feedback mechanisms to ensure precise gesture recognition and execution.

Deployment of digital assets is managed by the asset deployment engine (816), which operates based on real-time data and contextual information. This engine integrates with workflow management systems to automate and streamline the deployment process, ensuring that digital assets are provisioned timely and accurately. Enforcing the rules and policies related to asset management is the task of the asset management rule engine (818). This engine allows for the creation and modification of complex rule sets, integrating with other compliance management systems to maintain consistent and secure asset management practices.

Security is a paramount concern in this architecture, addressed by the homomorphic encryption layer (820). This layer ensures that data transmitted within the system remains secure, allowing computations to be performed on encrypted data without needing decryption first. This feature significantly enhances the system's overall data security. Complementing this encryption layer is the biometric database (822), which stores biometric data used for user authentication and identification, ensuring that only authorized personnel can access and manage digital assets.

Metadata plays a crucial role in this system, with the LiDAR metadata and image metadata component (824) storing critical spatial and visual data. This metadata is essential for asset management and anomaly detection, ensuring that all relevant data is accurately recorded and accessible. The deep learning module (826) further enhances the system's capabilities by analyzing large datasets to identify patterns and provide predictive insights for asset management. This module continuously updates its models based on new data, ensuring high accuracy and relevance of predictions. By improving decision-making and proactive management, the deep learning module allows the system to evolve and improve with changing needs and environments.

The asset anomaly event engine (828) is integral to maintaining the integrity of the asset management process. It detects compliance issues related to digital asset management and generates alerts for asset management associates (800). Using advanced anomaly detection techniques and customizable alert thresholds, this engine ensures timely identification of potential issues, enabling prompt corrective actions.

The flow of data within this architecture begins with the spatial scanning engine (802), which captures spatial data and sends it to the user asset extraction engine (804). This engine extracts detailed asset information and updates the user asset database (806). The spatial anchor programming engine (808) uses this data to create spatial anchors, which are stored in the anchor database (810). The asset orchestration engine (812) utilizes data from both the user asset and anchor databases to manage assets according to organizational policies, leveraging predictive insights from the deep learning module (826).

User inputs via gestures are processed by the gesture engine (814), which interacts with the asset deployment engine (816) to provision assets based on real-time and contextual information. The asset management rule engine (818) ensures all operations comply with organizational policies, while the homomorphic encryption layer (820) secures data transmissions. Biometric data from the biometric database (822) verifies user identities, ensuring secure access to the system.

The LiDAR metadata and image metadata (824) provide additional context for spatial and visual data, aiding in anomaly detection by the asset anomaly event engine (828). Alerts and insights generated by this engine are visualized through the visualization module (836), offering interactive dashboards and real-time data visualization tools to help asset management associates (800) make informed decisions.

Overall, FIG. 8 illustrates a highly sophisticated architecture for managing digital assets using spatial computing devices. It integrates advanced features such as LiDAR face detection, gesture-based controls, heatmap visualizations, real-time collaborative capabilities, and comprehensive data analysis. This system provides a robust, intuitive, and efficient solution for managing digital assets in modern organizations, representing a significant advancement in the field. The method enhances the precision, security, and efficiency of digital asset management, making it an indispensable tool for contemporary organizations.

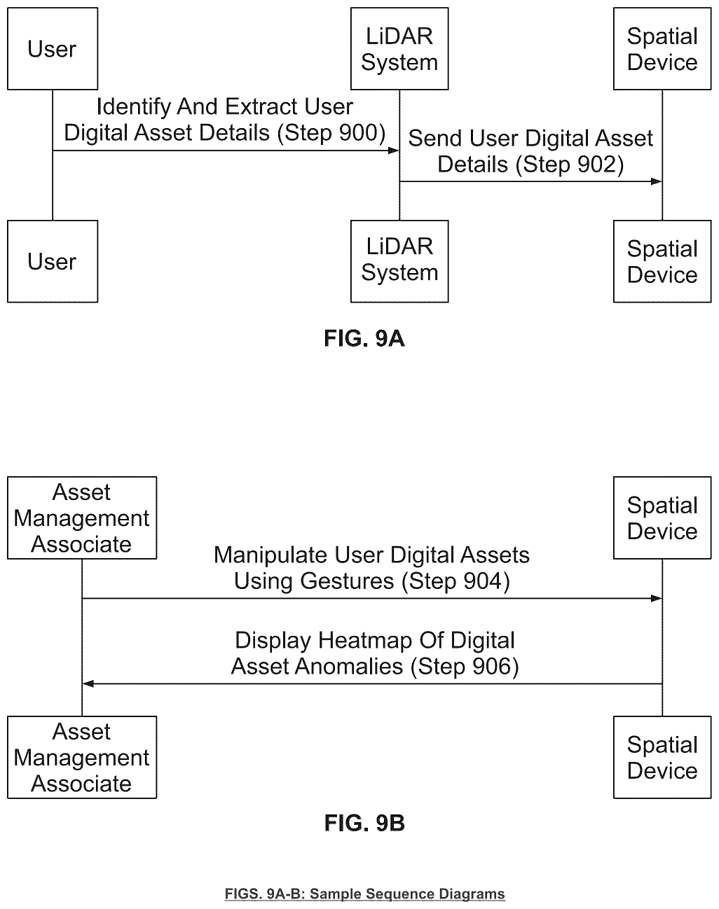

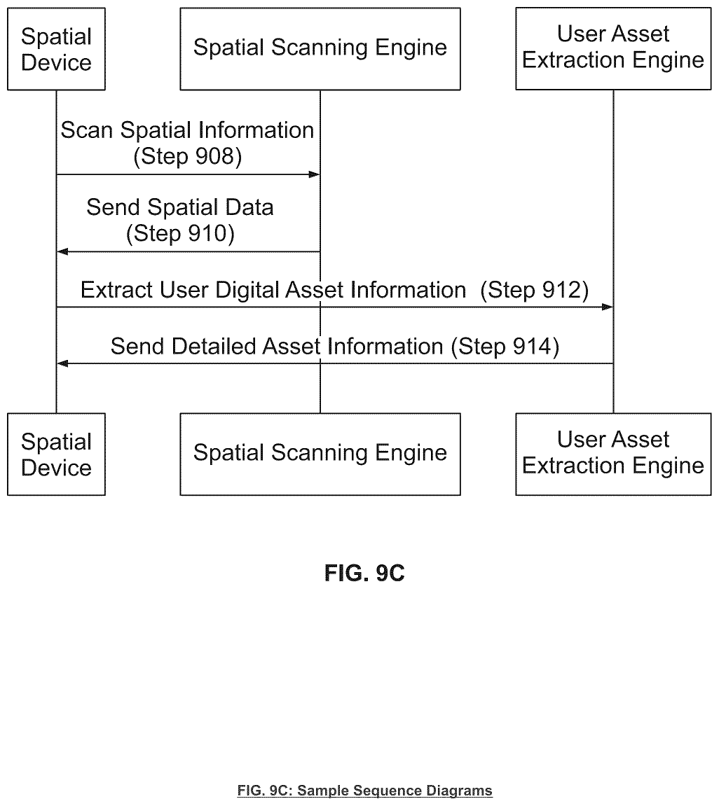

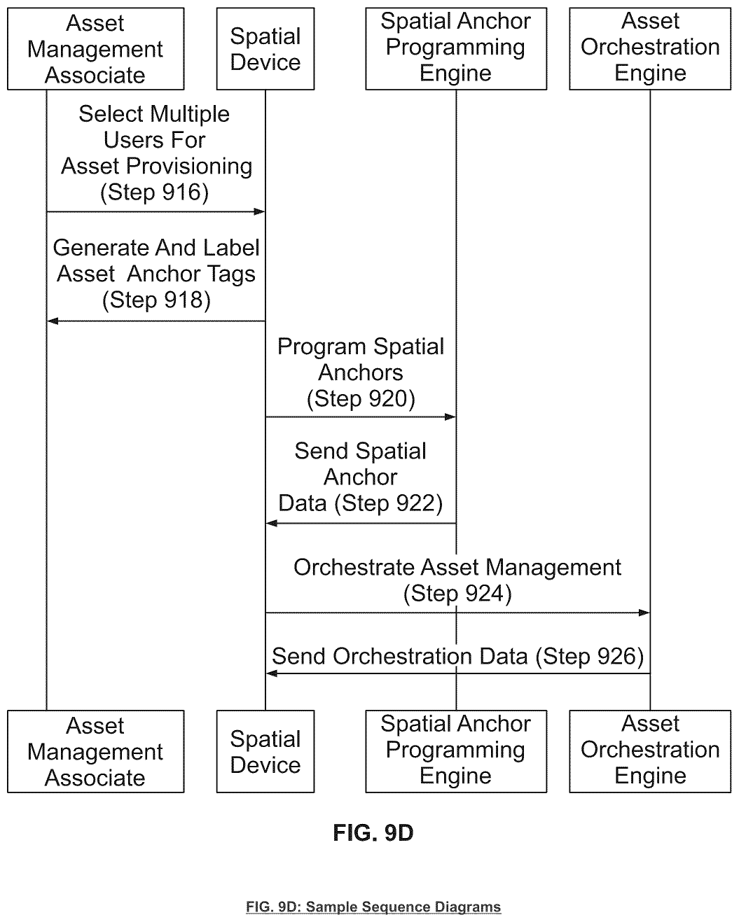

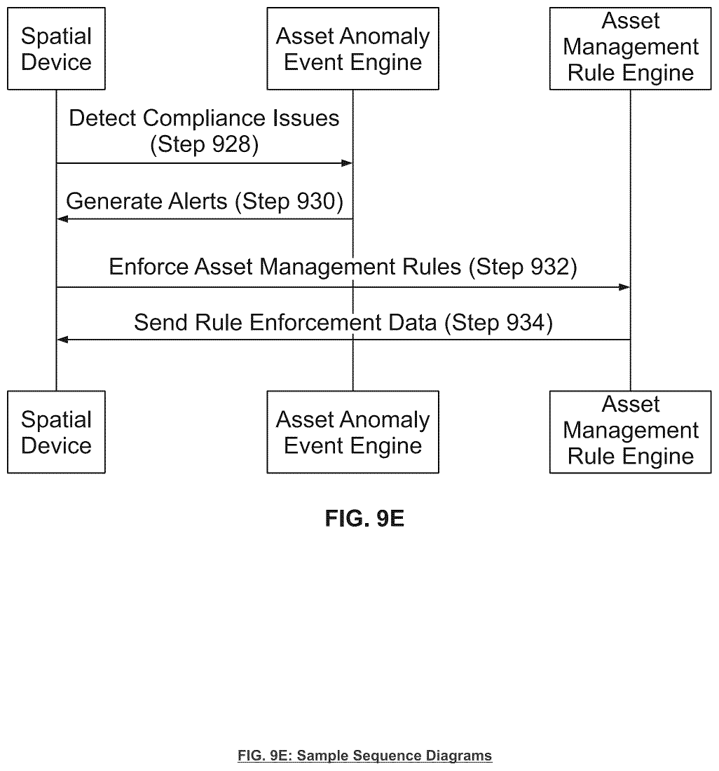

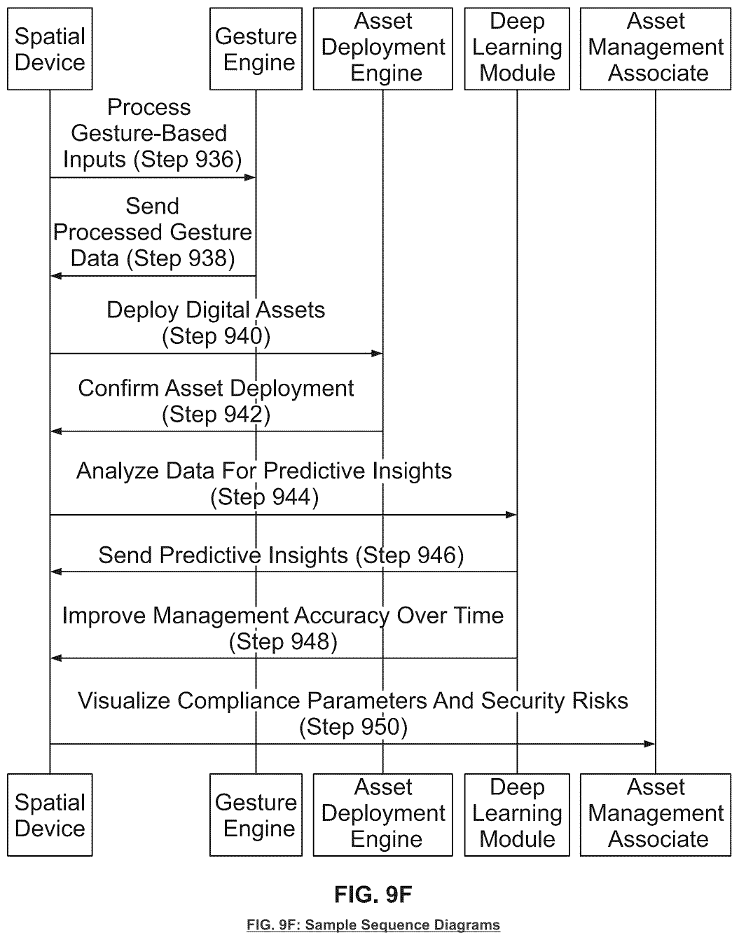

In FIGS. 9A-9F, a sequence diagram is depicted and presents a detailed process for managing and orchestrating digital assets using a spatial computing device. The process begins in FIG. 9A, where the LiDAR system identifies and extracts user digital asset details in Step 900. The spatial computing device captures these details, which may include various types of digital assets such as software licenses, hardware components, and user access permissions. The spatial device then sends these user digital asset details to the asset management associate in Step 902, ensuring that the associate has the necessary information to proceed with asset management tasks.

Moving to FIG. 9B, the asset management associate utilizes the spatial device to manipulate user digital assets using gesture-based controls in Step 904. This step involves an interactive interface where the associate can add, delete, transfer, or modify digital assets with simple gestures. The system's design ensures that these operations are intuitive and user-friendly, minimizing the need for extensive training. Following this, in Step 906, the system generates a heatmap displaying digital asset anomalies. This heatmap visualizes issues such as inadequate patch levels, outdated software versions, non-permissible software installations, antivirus status, software license expiration, and unauthorized server access, providing the associate with a clear overview of potential security risks.

FIG. 9C elaborates on the data extraction process. In Step 908, the spatial scanning engine scans the spatial information related to the users and their environment. This scanning captures high-resolution spatial data that is sent to the user asset extraction engine in Step 910. The extraction engine processes this data to extract detailed user digital asset information in Step 912. This detailed information, which includes specifics about each digital asset and its current status, is then sent back to the spatial device in Step 914. This step ensures that the asset management associate has access to comprehensive and up-to-date information, enabling informed decision-making.

In FIG. 9D, the asset management associate selects multiple users for asset provisioning in Step 916. This selection process is streamlined with advanced filtering and sorting options, allowing the associate to efficiently identify and select the appropriate users. The spatial anchor programming engine then generates and labels asset anchor tags in Step 918. These tags are crucial for tracking and managing digital assets, as they provide unique identifiers that link assets to specific users. The programming of spatial anchors occurs in Step 920, followed by the sending of spatial anchor data to the asset management associate in Step 922. This data is used in Step 924 to orchestrate the overall asset management process, ensuring that assets are provisioned and managed according to organizational policies. The orchestration data is sent in Step 926, completing this phase of the process.

In FIG. 9E, the asset anomaly event engine detects compliance issues in Step 928. These issues could include violations of security protocols, unauthorized software installations, or other deviations from established asset management policies. Upon detecting an issue, the system generates alerts in Step 930, notifying the asset management associate of the compliance problem. The associate can then take immediate corrective action to address the issue. In Step 932, the system enforces asset management rules, ensuring that all assets comply with organizational standards. The rule enforcement data is sent in Step 934, providing a record of the actions taken and ensuring accountability.

The final part of the sequence is detailed in FIG. 9F. In Step 936, the gesture engine processes gesture-based inputs from the asset management associate. These gestures are interpreted and converted into commands for managing digital assets. The processed gesture data is then sent in Step 938, leading to the deployment of digital assets in Step 940. This step ensures that assets are allocated correctly and efficiently to the selected users. The deployment is confirmed in Step 942, providing a record of the successful allocation. The system then analyzes the data for predictive insights in Step 944, using advanced analytics and machine learning to identify patterns and potential issues before they arise. These insights are sent in Step 946, helping the asset management associate make proactive decisions. Over time, the system improves its management accuracy in Step 948, learning from past data and continuously refining its processes. Finally, in Step 950, the system visualizes compliance parameters and security risks, providing an intuitive interface that helps the associate understand the overall security posture and identify areas that need attention.

This detailed sequence diagram demonstrates a comprehensive approach to digital asset management using spatial computing devices. By integrating advanced technologies such as LiDAR, gesture-based controls, heatmap visualizations, and real-time collaborative capabilities, the system enhances the efficiency, security, and accuracy of asset management practices. This approach ensures that digital assets are managed dynamically and responsively, adapting to the changing needs of the organization and maintaining compliance with security protocols.

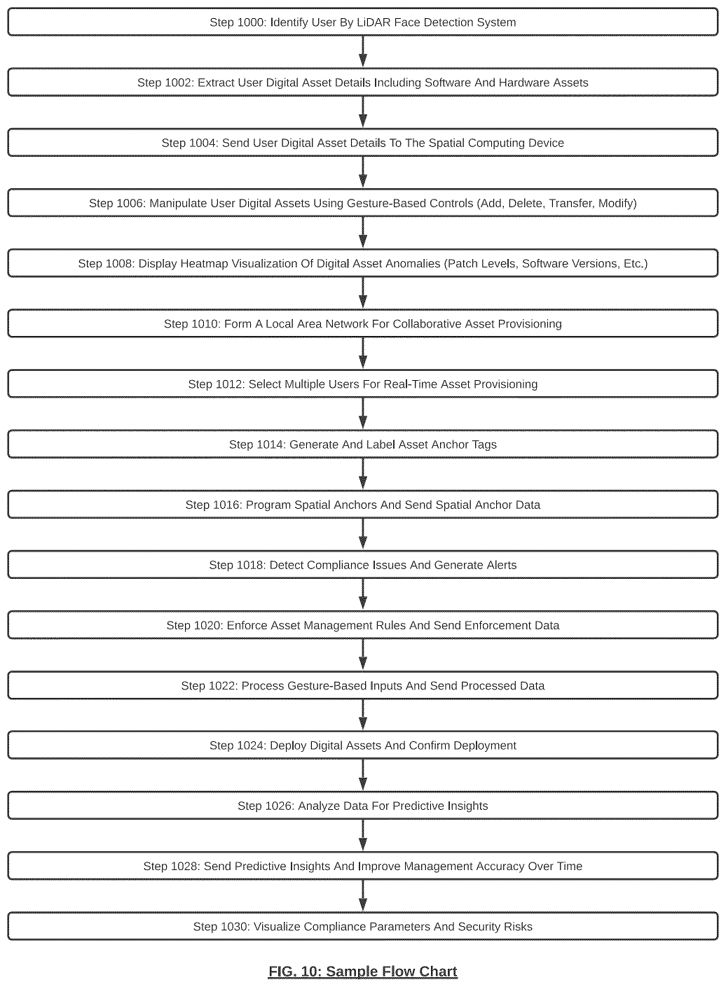

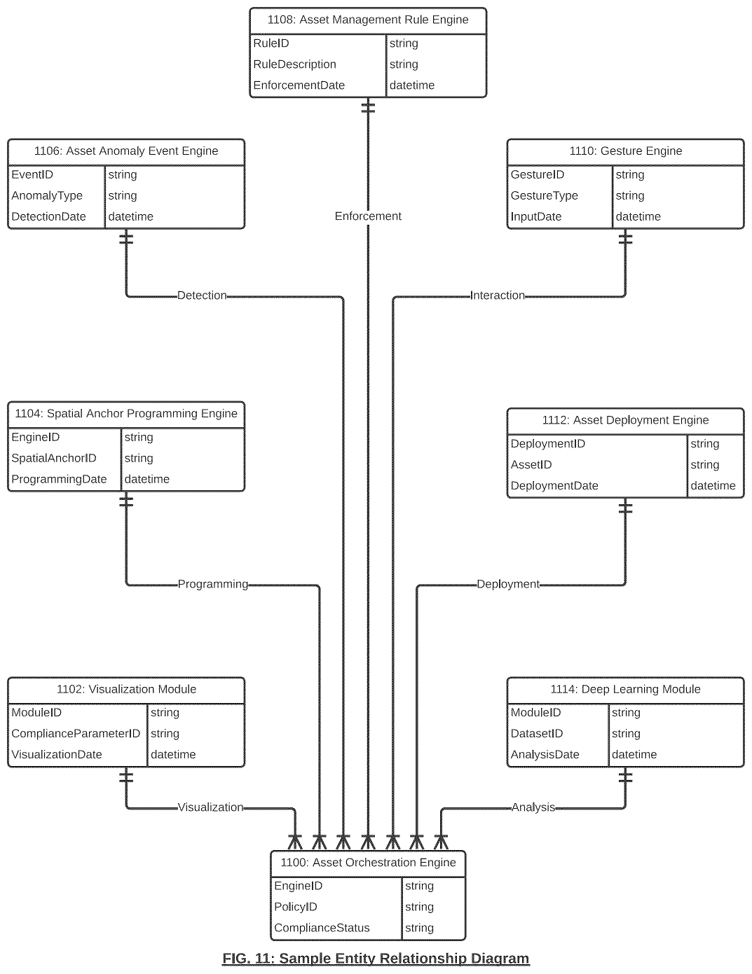

FIG. 10 illustrates an intricate and detailed flow chart that outlines the method for managing and orchestrating digital assets using a spatial computing device. The process begins with step 1000, where the system identifies the user by utilizing a sophisticated LiDAR face detection system integrated into the spatial computing device. This initial step is crucial as it ensures that the user is accurately recognized, allowing the system to manage the appropriate digital assets assigned to that particular user. This precise identification is essential for the subsequent steps to be effective and reliable.

Following the user identification, step 1002 involves extracting detailed information about the user's digital assets. These assets include both software and hardware components that are necessary for the user's role within the organization. The extracted information is comprehensive, encompassing all relevant data about the user's digital assets. In step 1004, this detailed information is sent to the spatial computing device. This transfer of data ensures that the asset management associate has access to the most up-to-date information about the user's digital assets, which is vital for making informed decisions and managing the assets effectively.

In step 1006, the asset management associate manipulates the user's digital assets using gesture-based controls. These gestures allow the associate to perform various actions such as adding, deleting, transferring, or modifying digital assets. The use of gesture-based controls makes the process intuitive and efficient, reducing the need for traditional input methods like keyboards or mice. This step leverages the advanced capabilities of the spatial computing device to streamline the asset management process.

The next step, 1008, involves displaying a heatmap visualization of digital asset anomalies on the spatial computing device. This heatmap provides a visual representation of various security and compliance issues related to the user's digital assets. Anomalies such as inadequate patch levels, outdated software versions, non-permissible software installations, antivirus status, software license expirations, and unauthorized server access are highlighted in this visualization. The heatmap enables the asset management associate to quickly identify and address these issues, ensuring that all digital assets comply with the organization's security policies and protocols.

Step 1010 entails forming a local area network (LAN) for collaborative asset provisioning. This step allows multiple asset management associates to work together in real-time, facilitating efficient communication and coordination. By creating a LAN, the system ensures that asset management practices are consistent and comprehensive across the organization. This collaborative environment is essential for managing digital assets in dynamic and complex organizational settings.

In step 1012, the system selects multiple users simultaneously for real-time asset provisioning. This capability is particularly useful in scenarios where multiple users require updates or changes to their digital assets at the same time. By enabling the simultaneous selection and provisioning of multiple users, the system significantly improves operational efficiency and responsiveness to organizational needs.

Step 1014 involves generating and labeling asset anchor tags. These tags are crucial for tracking and managing digital assets accurately. The asset anchor tags provide unique identifiers for each asset, ensuring that they can be easily tracked and managed throughout their lifecycle. In step 1016, the system programs the spatial anchors and sends the spatial anchor data to the relevant components. This step ensures that the asset tagging and tracking process is precise and efficient.

The next step, 1018, detects compliance issues and generates alerts to prompt immediate corrective actions. This step is vital for maintaining the integrity and security of the digital assets. By continuously monitoring the assets for compliance issues, the system ensures that any potential risks are identified and addressed promptly. Step 1020 focuses on enforcing asset management rules, ensuring that all digital assets comply with organizational policies and procedures. This enforcement is critical for maintaining a secure and compliant digital environment.

In step 1022, the system processes gesture-based inputs from the asset management associate and sends the processed data to the relevant components. This step facilitates intuitive and efficient control over digital assets, allowing the associate to manage the assets with ease. Step 1024 involves deploying digital assets and confirming their deployment. This step ensures that the digital assets are provisioned accurately and promptly, meeting the needs of the users and the organization.

Step 1026 entails analyzing data to generate predictive insights. These insights are crucial for proactive asset management, allowing the organization to anticipate and address potential issues before they become critical. By leveraging advanced analytics, the system can optimize asset utilization and improve overall management practices. In step 1028, the system sends these predictive insights to improve management accuracy over time. This continuous improvement ensures that the system evolves and adapts to meet changing organizational needs and challenges.

Finally, step 1030 visualizes compliance parameters and security risks on the spatial computing device. This visualization provides asset management associates with clear and actionable insights, enabling them to make informed decisions about digital asset management. By presenting the data in an intuitive and accessible format, the system enhances the overall efficiency and effectiveness of digital asset management. This method, detailed in the claims, outlines a dynamic and integrated approach to managing digital assets using advanced technologies such as LiDAR, gesture recognition, and augmented reality. The comprehensive and detailed process ensures that digital assets are managed efficiently, securely, and effectively, meeting the demands of modern organizations.

FIG. 11 presents a detailed and intricate entity relationship diagram (ERD) for a digital asset management system that leverages a spatial computing device to orchestrate and manage digital assets. At the core of this diagram is the Asset Orchestration Engine, labeled as 1100. This engine plays a pivotal role in the overall management of digital assets, ensuring that the orchestration adheres to the organizational policies and procedures. It incorporates advanced algorithms and integrates machine learning to optimize asset allocation and utilization based on historical data and predictive analytics, ensuring that asset management practices are both efficient and compliant with the established guidelines.

The Visualization Module, designated as 1102, is directly connected to the Asset Orchestration Engine. This module is tasked with visualizing compliance parameters and security risks. It processes data inputs, including module IDs, dataset IDs, and analysis dates, to generate comprehensive visual representations of the current state of digital assets. The visualization process provides asset management associates with clear and actionable insights, presented through interactive dashboards, customizable reports, and real-time data visualization tools. This enhances the decision-making process, allowing associates to quickly identify and address potential compliance issues and security risks.

Adjacent to the Visualization Module is the Spatial Anchor Programming Engine, labeled as 1104. This engine is responsible for the programming and management of spatial anchors, which are used to tag and track digital assets within the spatial computing environment. It manages spatial anchor IDs and programming dates, ensuring that each asset is accurately tagged with unique identifiers. This tagging process is crucial for maintaining precise asset tracking throughout the asset's lifecycle, enabling efficient management and retrieval of digital assets.

The Asset Anomaly Event Engine, marked as 1106, is another critical component of the system. This engine is designed to detect and report compliance issues and anomalies related to digital asset management. It records parameters such as event IDs, anomaly types, and detection dates. By continuously monitoring digital assets for anomalies, the engine generates alerts that prompt immediate corrective actions. This proactive approach is vital for maintaining the integrity and security of digital assets, as it ensures that any potential threats or compliance breaches are identified and addressed swiftly.

Connected to the Asset Anomaly Event Engine is the Asset Management Rule Engine, designated as 1108. This engine enforces the organizational rules and policies governing digital asset management. It tracks rule IDs, rule descriptions, and enforcement dates, ensuring that all digital assets are managed in accordance with the predefined guidelines and standards. The rule engine integrates with other compliance management systems, allowing for the creation and modification of complex rule sets and ensuring consistent enforcement across the organization. This integration is crucial for maintaining a secure and compliant asset management environment.

The Gesture Engine, labeled as 1110, processes gesture-based inputs from asset management associates. It manages gesture IDs, gesture types, and input dates, facilitating an intuitive and efficient control mechanism over digital assets. By supporting a wide range of customizable gesture sets and providing real-time feedback mechanisms, the Gesture Engine ensures accurate recognition and execution of gestures. This makes the system more user-friendly and interactive, allowing asset management associates to manage digital assets seamlessly through natural and intuitive gestures.

Adjacent to the Gesture Engine is the Asset Deployment Engine, marked as 1112. This engine handles the deployment of digital assets to users, ensuring that assets are provisioned accurately and promptly based on real-time data and contextual information. It tracks deployment IDs, asset IDs, and deployment dates, coordinating with other system components to automate and streamline the deployment process. This engine ensures that digital assets are deployed efficiently, aligning with the dynamic needs of the organization and minimizing downtime.

The Deep Learning Module, labeled as 1114, is a sophisticated component that enhances the system's capabilities through advanced analytics and machine learning. It analyzes large datasets to identify patterns and generate predictive insights for digital asset management. This module manages dataset IDs and analysis dates, continuously updating its models based on new data to ensure high accuracy and relevance of predictions. By leveraging deep learning, the system can anticipate potential issues and optimize asset management practices, improving decision-making and proactive management.

The diagram also highlights the interconnected nature of these components, showing how they work together to provide a comprehensive and integrated approach to digital asset management. For example, the Asset Anomaly Event Engine and the Asset Management Rule Engine work in tandem to ensure that compliance issues are detected and addressed in accordance with organizational policies. Similarly, the Gesture Engine and the Asset Deployment Engine collaborate to provide an intuitive and efficient asset provisioning process.

Overall, the ERD in FIG. 11 encapsulates the complexity and interconnectedness of the digital asset management system. It underscores the importance of each component in maintaining a secure, efficient, and responsive asset management environment. The system leverages advanced technologies such as LiDAR, gesture recognition, and deep learning to enhance the efficiency, security, and effectiveness of digital asset management. This comprehensive approach ensures that digital assets are managed dynamically and in real-time, meeting the evolving needs of modern organizations and providing a robust framework for secure and compliant digital asset management.

Pseudocode samples for implementing one or more aspects of the invention are set forth below for reference and focuses on the management and orchestration of digital assets using spatial computing devices, can be broken down into several key components. The pseudocode and explanation provided below cover aspects such as user identification, asset manipulation, real-time anomaly detection, and collaborative asset provisioning.

```
// Initialize spatial computing device and its modules
initializeSpatialComputingDevice( )
initializeLiDARSystem( )
initializeAugmentedRealityInterface( )
initializeGestureControlSystem( )
initializeHeatmapVisualizationModule( )
initializeNetworkingModule( )
initializeSpatialScanningEngine( )
initializeUserAssetExtractionEngine( )
initializeSpatialAnchorProgrammingEngine( )
initializeAssetOrchestrationEngine( )
initializeAssetAnomalyEventEngine( )
initializeAssetManagementRuleEngine( )
initializeDeepLearningModule( )
initializeVisualizationModule( )
// Identify user using LiDAR face detection system
function identifyUser( ) {
  user = LiDARSystem.detectUser( )
  userDetails = extractUserDigitalAssetDetails(user)
  return userDetails
}
// Extract user digital asset details
function extractUserDigitalAssetDetails(user) {
  return UserAssetExtractionEngine.getDetails(user)
}
// Manipulate user digital assets using gestures
function manipulateDigitalAssets(userDetails, action, asset) {
  if action == “add” {
    GestureControlSystem.addAsset(userDetails, asset)
  } else if action == “delete” {
    GestureControlSystem.deleteAsset(userDetails, asset)
  } else if action == “transfer” {
    GestureControlSystem.transferAsset(userDetails, asset)
  } else if action == “modify” {
    GestureControlSystem.modifyAsset(userDetails, asset)
  }
}
// Display heatmap of digital asset anomalies
function displayHeatmap(userDetails) {
  anomalies = AssetAnomalyEventEngine.detectAnomalies(userDetails)
  HeatmapVisualizationModule.display(anomalies)
}
// Form local area network for collaborative asset provisioning
function formCollaborativeNetwork( ) {
  NetworkingModule.pairDevices( )
}
// Select multiple users for real-time asset provisioning
function selectMultipleUsers(users) {
  selectedUsers = UserSelectionModule.selectUsers(users)
  return selectedUsers
}
// Generate asset anchor tags and label them
function generateAndLabelAssetTags(users) {
  for user in users {
    tag = SpatialAnchorProgrammingEngine.createTag(user)
    SpatialAnchorProgrammingEngine.labelTag(tag, user)
  }
}
// Recognize users' location and spatial attributes for context-aware management
function recognizeSpatialAttributes(user) {
  location = SpatialRecognitionModule.getLocation(user)
  spatialMap = SpatialRecognitionModule.getSpatialMap(location)
  return spatialMap
}
// Deploy digital assets to users
function deployAssets(users, assets) {
  for user in users {
    for asset in assets {
      AssetDeploymentEngine.deploy(user, asset)
    }
  }
  AssetDeploymentEngine.confirmDeployment(users, assets)
}
// Detect compliance issues and generate alerts
function detectAndAlertComplianceIssues(userDetails) {
  issues = AssetAnomalyEventEngine.detectComplianceIssues(userDetails)
  if issues {
    AssetAnomalyEventEngine.generateAlerts(issues)
  }
}
// Visualize compliance parameters and security risks
function visualizeComplianceAndSecurity(userDetails) {
  risks = VisualizationModule.getComplianceParameters(userDetails)
  VisualizationModule.display(risks)
}
// Main function to manage and orchestrate digital assets
function manageAndOrchestrateAssets(users, assets) {
  userDetails = identifyUser( )
  manipulateDigitalAssets(userDetails, “add”, assets[0])
  displayHeatmap(userDetails)
  formCollaborativeNetwork( )
  selectedUsers = selectMultipleUsers(users)
  generateAndLabelAssetTags(selectedUsers)
  spatialMap = recognizeSpatialAttributes(userDetails)
  deployAssets(selectedUsers, assets)
  detectAndAlertComplianceIssues(userDetails)
  visualizeComplianceAndSecurity(userDetails)
}
// Start the asset management process
manageAndOrchestrateAssets(userList, assetList)
```

By way of a more detailed explanation, the foregoing pseudocode begins by initializing various components of the spatial computing device, such as the LiDAR system, augmented reality interface, gesture control system, and other necessary modules. These components are essential for the functionality described in the invention.

The ‘identifyUser’ function uses the LiDAR face detection system to identify a user and extract their digital asset details using the ‘UserAssetExtractionEngine’.

The ‘manipulateDigitalAssets’ function enables the asset management associate to manipulate digital assets (add, delete, transfer, modify) using gesture-based controls provided by the ‘GestureControlSystem’.

The ‘displayHeatmap’ function uses the ‘AssetAnomalyEventEngine’ to detect anomalies in the user's digital assets and visualizes them through the ‘HeatmapVisualizationModule’.

The ‘formCollaborativeNetwork’ function initializes a local area network for collaborative asset provisioning using the ‘NetworkingModule’.

The ‘selectMultipleUsers’ function allows for the selection of multiple users for real-time asset provisioning, utilizing the ‘UserSelectionModule’.

The ‘generateAndLabelAssetTags’ function generates asset anchor tags for each selected user and labels them accordingly using the ‘SpatialAnchorProgrammingEngine’.

The ‘recognizeSpatialAttributes’ function identifies the user's location and spatial attributes, providing context-aware management through the ‘SpatialRecognitionModule’.

The ‘deployAssets’ function deploys digital assets to the selected users and confirms the deployment using the ‘AssetDeploymentEngine’.

The ‘detectAndAlertCompliancelssues’ function detects compliance issues in the user's digital assets and generates alerts through the ‘AssetAnomalyEventEngine’.

Finally, the ‘visualizeComplianceAndSecurity’ function visualizes compliance parameters and security risks associated with the user's digital assets using the ‘VisualizationModule’.

The main function, ‘manageAndOrchestrateAssets’, coordinates the entire process, starting with user identification and ending with compliance visualization, ensuring efficient and secure digital asset management. This pseudocode provides a comprehensive framework for implementing the advanced digital asset management system described in the invention.

With respect to modifications and alternate embodiments of various aspects of the invention, all of which are within the spirit and scope of this disclosure, the following will be readily apparent to skilled artisans.

Alternate embodiments for implementing the various aspects of the invention should consider different technologies and approaches while remaining within the spirit and scope of the disclosure. Instead of relying solely on LiDAR, different sensing technologies such as ultrasonic sensors could be employed for spatial mapping and user detection. These sensors measure distances using sound waves and can be a cost-effective alternative for specific applications, offering precise detection even in environments where light conditions are not ideal. Infrared technology could also be utilized to detect user presence and movement. This technology excels in low-light environments where traditional cameras might struggle, providing a reliable alternative for user detection.

For user identification, biometric authentication methods like fingerprint, iris, or voice recognition could enhance security and provide additional options beyond face detection. Fingerprint recognition is already widely used and offers a high level of security. Iris recognition can provide even more precise identification, though it may require more sophisticated equipment. Voice recognition can offer a hands-free identification method, enhancing user convenience and accessibility. Alternatively, users could carry RFID tags that the system reads to identify and track them within a certain range. This method provides a non-visual identification solution that can be highly reliable and easy to implement in various environments.

The user interface could be enhanced with voice recognition for asset management tasks. Integrating voice commands would provide a hands-free interaction option, making the system more accessible and convenient, especially for users who need to multitask. Additionally, incorporating haptic feedback into the spatial computing device could enhance the user experience by providing tactile responses to user interactions. This feedback can make interactions more intuitive and satisfying, especially in applications where visual or auditory feedback might be insufficient.

Visualization methods could also be improved. Using 3D holographic displays to visualize digital assets and anomalies would provide a more immersive and detailed view compared to traditional AR interfaces. Holographic displays can offer a depth of field and spatial context that flat screens cannot, making it easier to understand complex data sets and relationships. Similarly, implementing a virtual reality interface could offer a completely immersive environment for managing and orchestrating digital assets. This approach would be especially suitable for training and complex visualization tasks, allowing users to interact with assets in a fully simulated environment that can closely mimic real-world conditions.

For collaborative tools, cloud-based collaboration platforms could be integrated, allowing asset management associates to work together remotely. These platforms can provide real-time data sharing and communication, making it easier for teams to collaborate regardless of their physical location. This approach provides flexibility and scalability, enabling organizations to leverage global talent and resources. Additionally, using blockchain technology to track and manage digital assets could enhance security and transparency. Blockchain ensures that asset history and transactions are immutable and easily auditable, providing a robust method for ensuring data integrity and security.

Advanced anomaly detection could be achieved by leveraging more sophisticated AI and machine learning algorithms. These technologies can predict potential security risks and non-compliance issues before they occur, providing proactive management capabilities. AI-driven predictive analytics can analyze large datasets to identify patterns and trends that might indicate emerging threats, allowing for early intervention. Incorporating crowdsourced data from multiple users and devices to enhance the anomaly detection process could provide a broader and more comprehensive understanding of potential issues. This approach leverages the collective insights of a larger user base, improving the system's ability to detect anomalies that might not be apparent from a single perspective.

The system could be integrated with other technologies and platforms. For instance, integrating Internet of Things (IoT) devices to monitor and manage physical assets in conjunction with digital assets could create a more holistic asset management system. IoT devices can provide real-time data on the status and condition of physical assets, enabling more comprehensive monitoring and management. Connecting the asset management system with existing Enterprise Resource Planning (ERP) systems could ensure seamless data flow and integration with other organizational processes. This integration can streamline workflows and improve efficiency by ensuring that all systems are aligned and working together.

Alternative deployment models could also be considered. Deploying certain components of the asset management system on edge devices could reduce latency and improve real-time processing capabilities. Edge computing allows data to be processed closer to where it is generated, reducing the time it takes to analyze and act on that data. This approach is particularly useful in environments with limited connectivity, where relying on cloud-based processing might introduce unacceptable delays. Utilizing a hybrid cloud approach, where sensitive data and critical operations are managed on-premises while leveraging cloud resources for scalability and collaboration, could offer a balanced solution. This model provides the security and control of on-premises systems with the flexibility and scalability of cloud services.

Customizable rule engines would enhance the system's flexibility. Allowing asset management associates to define and customize rules and policies for asset management based on specific organizational needs and contexts would make the system more adaptable. This capability ensures that the system can meet the unique requirements of different organizations, improving its effectiveness and relevance. Implementing systems that automatically update rules and policies based on regulatory changes and security advisories could ensure compliance and reduce the manual effort required to keep the system up-to-date. This approach ensures that the system remains current with the latest best practices and regulatory requirements, reducing the risk of non-compliance and enhancing overall security.

By considering these alternate embodiments, the system can be adapted to various operational environments and use cases, enhancing its flexibility, scalability, and effectiveness in managing and orchestrating digital assets. These alternate embodiments offer a range of technologies and approaches that can be tailored to meet the specific needs and challenges of different organizations, ensuring that the system remains relevant and effective in a rapidly changing technological landscape. All are within the scope of this disclosure.

Although the present technology has been described based on what is currently considered the most practical and preferred implementations, it is to be understood that this detail is only for that purpose and this disclosure is not limited to the sample descriptions and implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A method for managing and orchestrating digital assets leveraging spatial computing devices, comprising:
identifying, by a LiDAR face detection system integrated with a spatial computing device, a user and extracting user digital asset details including information on assigned digital and physical computing assets;
manipulating, by an asset management associate using gesture-based controls on the spatial computing device, user digital assets through an interactive spatial computing interface, the manipulation including adding, deleting, transferring, or modifying user digital assets and altering access provisioning for the user;
displaying, by the spatial computing device, a heatmap visualization of digital asset anomalies associated with user information security issues, the anomalies including inadequate patch levels, outdated software versions, non-permissible software installations, antivirus status, software license expiration, and unauthorized server access;
forming, by pairing spatial computing devices, a local area network with other asset management associates for interactive collaborative asset provisioning, enabling real-time communication and coordination among associates;
selecting, by the asset management associate using the spatial computing device, multiple users simultaneously for real-time asset provisioning, allowing for efficient and concurrent management of digital assets;
generating, by the spatial computing device, asset anchor tags and labeling them to users for tracking and management of digital assets, ensuring accurate tagging and easy retrieval of asset information;
recognizing, by the spatial computing device, users' location spatial maps including surroundings and geolocation, and enabling provisioning of digital assets until the asset management associate sees the user in a defined spatial map and geolocation in real-time, thereby providing context-aware asset management;
scanning, by a spatial scanning engine, spatial information related to users and their environments, ensuring precise and detailed spatial data collection; and
extracting, by a user asset extraction engine, detailed information about user digital assets, providing comprehensive and up-to-date asset information.

2. The method of claim 1, further comprising: programming, by a spatial anchor programming engine, spatial anchors for tagging and tracking digital assets, facilitating the management and organization of digital assets based on spatial anchors.

3. The method of claim 2, further comprising: orchestrating, by an asset orchestration engine, overall management of digital assets according to organizational policies and procedures, ensuring compliance and efficient asset utilization.

4. The method of claim 3, further comprising: detecting, by an asset anomaly event engine, compliance issues related to digital asset management and generating alerts for asset management associates, enabling prompt corrective actions.

5. The method of claim 4, further comprising: enforcing, by an asset management rule engine, organizational rules and policies related to digital asset management, maintaining consistent and secure asset management practices.

6. The method of claim 5, further comprising: processing, by a gesture engine, gesture-based inputs from asset management associates for controlling and managing digital assets, enhancing user interaction and control over digital assets.

7. The method of claim 6, further comprising: deploying, by an asset deployment engine, digital assets to users based on real-time data and contextual information, ensuring timely and accurate provisioning of assets.

8. The method of claim 7, further comprising: analyzing, by a deep learning module, large datasets to identify patterns and provide predictive insights for digital asset management, improving decision-making and proactive management.

9. The method of claim 8, further comprising: improving, by the deep learning module, accuracy and efficiency of digital asset management over time through continuous learning and adaptation, ensuring the system evolves with changing needs and environments.

10. The method of claim 9, further comprising: visualizing, by the spatial computing device, compliance parameters and security risks through an intuitive user interface to assist asset management associates in making informed decisions, enhancing overall efficiency and effectiveness of digital asset management.

11. A system for managing and orchestrating digital assets leveraging spatial computing devices, comprising:
a LiDAR face detection system integrated with a spatial computing device configured to identify a user and extract user digital asset details including information on assigned digital and physical computing assets, wherein the LiDAR face detection system provides precise and reliable user identification under various lighting and environmental conditions;
a gesture-based control interface on the spatial computing device configured to allow an asset management associate to manipulate user digital assets, the manipulation including adding, deleting, transferring, or modifying user digital assets and altering access provisioning for the user, wherein the gesture-based control interface recognizes a wide range of gestures to ensure accurate and intuitive control;
a heatmap visualization module on the spatial computing device configured to display digital asset anomalies associated with user information security issues, the anomalies including inadequate patch levels, outdated software versions, non-permissible software installations, antivirus status, software license expiration, and unauthorized server access, wherein the heatmap visualization module provides real-time updates and interactive features for detailed anomaly analysis;
a networking module on the spatial computing device configured to pair with other spatial computing devices to form a local area network for interactive collaborative asset provisioning, enabling real-time communication and coordination among asset management associates, wherein the networking module supports secure and encrypted communication channels to protect sensitive data;
a user selection module on the spatial computing device configured to allow the asset management associate to select multiple users simultaneously for real-time asset provisioning, allowing for efficient and concurrent management of digital assets, wherein the user selection module provides advanced filtering and sorting options to streamline a selection process;
an asset tagging module on the spatial computing device configured to generate asset anchor tags and label them to users for tracking and management of digital assets, ensuring accurate tagging and easy retrieval of asset information, wherein the asset tagging module utilizes unique identifiers and metadata for comprehensive asset tracking;
a spatial recognition module on the spatial computing device configured to recognize users' location spatial maps including surroundings and geolocation, and enable provisioning of digital assets until the asset management associate sees the user in a defined spatial map and geolocation in real-time, thereby providing context-aware asset management, wherein the spatial recognition module integrates with geolocation services to enhance accuracy and context-awareness;
a spatial scanning engine configured to scan and identify spatial information related to users and their environments, ensuring precise and detailed spatial data collection, wherein the spatial scanning engine supports high-resolution scanning and real-time data processing; and
a user asset extraction engine configured to extract detailed information about user digital assets, providing comprehensive and up-to-date asset information, wherein the user asset extraction engine interfaces with various asset management databases and systems to ensure comprehensive data extraction.

12. The system of claim 11, further comprising: a spatial anchor programming engine configured to program spatial anchors for tagging and tracking digital assets, facilitating the management and organization of digital assets based on spatial anchors, wherein the spatial anchor programming engine supports dynamic anchor adjustments and multi-anchor configurations for enhanced tracking accuracy.

13. The system of claim 12, further comprising: an asset orchestration engine configured to manage overall orchestration of digital assets according to organizational policies and procedures, ensuring compliance and efficient asset utilization, wherein the asset orchestration engine incorporates machine learning algorithms to optimize asset allocation and utilization based on historical data and predictive analytics.

14. The system of claim 13, further comprising: an asset anomaly event engine configured to detect compliance issues related to digital asset management and generate alerts for asset management associates, enabling prompt corrective actions, wherein the asset anomaly event engine utilizes advanced anomaly detection techniques and customizable alert thresholds to ensure timely identification of potential issues.

15. The system of claim 14, further comprising: an asset management rule engine configured to enforce organizational rules and policies related to digital asset management, maintaining consistent and secure asset management practices, wherein the asset management rule engine allows for creation and modification of complex rule sets and integrates with other compliance management systems for comprehensive policy enforcement.

16. The system of claim 15, further comprising: a gesture engine configured to process gesture-based inputs from asset management associates for controlling and managing digital assets, enhancing user interaction and control over digital assets, wherein the gesture engine supports customizable gesture sets and provides feedback mechanisms to ensure accurate gesture recognition and execution.

17. The system of claim 16, further comprising: an asset deployment engine configured to deploy digital assets to users based on real-time data and contextual information, ensuring timely and accurate provisioning of assets, wherein the asset deployment engine integrates with workflow management systems to automate and streamline a deployment process.

18. The system of claim 17, further comprising: a deep learning module configured to analyze large datasets to identify patterns and provide predictive insights for digital asset management, improving decision-making and proactive management, wherein the deep learning module continuously updates its models based on new data to ensure high accuracy and relevance of predictions.

19. The system of claim 18, further comprising: a visualization module on the spatial computing device configured to visualize compliance parameters and security risks through an intuitive user interface to assist asset management associates in making informed decisions, enhancing overall efficiency and effectiveness of digital asset management, wherein the visualization module provides interactive dashboards, customizable reports, and real-time data visualization tools.

20. A method for managing digital assets leveraging spatial computing devices, comprising:
identifying, by a spatial computing device, a user and extracting user digital asset details including information on assigned digital and physical computing assets;
manipulating, by an asset management associate using the spatial computing device, user digital assets through an interactive interface, the manipulation including adding, deleting, transferring, or modifying user digital assets and altering access provisioning for the user;
displaying, by the spatial computing device, digital asset anomalies associated with user information security issues;
forming, by the spatial computing device, a network with other asset management associates for collaborative asset provisioning;
selecting, by the asset management associate using the spatial computing device, multiple users for asset provisioning;
generating, by the spatial computing device, asset tags and labeling them to users for tracking and management of digital assets; and
recognizing, by the spatial computing device, users' locations and enabling provisioning of digital assets until the asset management associate sees the user in a defined spatial map and geolocation in real-time.
